(19) United States
(12) Patent Application Publication
(10) Pub. No.: US 2024/0085531 A1
(43) Pub. Date: Mar. 14, 2024

(54) OPTO-MECHANICAL SYSTEM

(71) Applicant: SUTENG INNOVATION TECHNOLOGY CO., LTD., Shenzhen (CN)

(72) Inventors: Youxue LEI, Shenzhen (CN); Yue ZHOU, Shenzhen (CN)

(73) Assignee: SUTENG INNOVATION TECHNOLOGY CO., LTD., Shenzhen (CN)

(21) Appl. No.: 18/139,915

(22) Filed: Apr. 26, 2023

(30) Foreign Application Priority Data
Apr. 29, 2022 (CN) 202210467342.9
Apr. 29, 2022 (CN) 202210468850.9

(51) Int. Cl. G01S 7/481

(52) U.S. Cl. CPC G01S 7/4817; G01S 7/4813; G01S 7/4816

(57) ABSTRACT

An opto-mechanical system is provided. The opto-mechanical system includes a light emission assembly, a light receiving assembly, a mainboard, a light scanning assembly, and an electronic control board. The mainboard is electrically connected to the light emission assembly and configured to control the light emission assembly to emit an emission light signal to the target object, and is electrically connected to the light receiving assembly and configured to control the light receiving assembly to receive an echo light signal reflected by a target object. The emission light signal is transmitted by the light scanning assembly to the target object, and the echo light signal is transmitted by the light scanning assembly to the light receiving assembly. The electronic control board is disposed independently of the mainboard and electrically connected to the mainboard, and is electrically connected to the light scanning assembly to control movements of the light scanning assembly.

### CROSS-REFERENCE TO RELATED APPLICATION

The present application claims the benefit of priority to Chinese Patent Application No. 202210467342.9, filed on Apr. 29, 2022, and to Chinese Patent Application No. 202210468850.9, filed on Apr. 29, 2022, which are hereby incorporated by reference in their entireties.

### TECHNICAL FIELD

This application relates to the field of light technologies, and in particular, to an opto-mechanical system.

### BACKGROUND

An opto-mechanical system refers to a device that emits an emission light signal to a target in external space and then receives an echo light signal from the target to obtain information such as a distance between the opto-mechanical system and the target after an analysis and a comparison of the emission light signal and the echo light signal. The opto-mechanical system is widely applied by virtue of its data characteristics such as instantaneity, stability, and sufficiency. However, heat dissipation performance of the opto-mechanical system may be poor, shielding performance of the opto-mechanical system is poor.

### SUMMARY

Embodiments of this application provide an opto-mechanical system, to resolve a problem of poor heat dissipation performance of an opto-mechanical system. Technical solutions are as follows:

According to a first aspect, some embodiments of this application provide an opto-mechanical system, including: a light emission assembly; a light receiving assembly; a mainboard, electrically connected to the light emission assembly and configured to control the light emission assembly to emit an emission light signal to a target object, where the mainboard is electrically connected to the light receiving assembly and configured to control the light receiving assembly to receive an echo light signal reflected by the target object; a light scanning assembly, where the emission light signal is transmitted by the light scanning assembly to the target object, and the echo light signal is transmitted by the light scanning assembly to the light receiving assembly; and an electronic control board, disposed independently of the mainboard and electrically connected to the mainboard, where the electronic control board is electrically connected to the light scanning assembly to control a movement of the light scanning assembly.

In the opto-mechanical system in some embodiments of this application, the electronic control board and the mainboard are disposed independently. Compared with integrated disposition, the heat dissipation performance of the opto-mechanical system can be improved. When the product needs iteration or is inconsistent with a requirement of a customer, only the electronic control board needs to be disassembled and replaced, which reduces replacement cost and improves replacement efficiency.

Some embodiments of another aspect of this application provide an opto-mechanical system, to resolve a problem of poor shielding performance of the opto-mechanical system.

According to a second aspect, some embodiments of this application provide an opto-mechanical system, including: a light emission assembly; a light receiving assembly; a mainboard, electrically connected to the light emission assembly and configured to control the light emission assembly to emit an emission light signal to an irradiated object, where the mainboard is electrically connected to the light receiving assembly and configured to control the light receiving assembly to receive the echo light signal reflected by the irradiated object; a housing forming a first accommodating cavity, where the light emission assembly, the light receiving assembly, and the mainboard are all located in the first accommodating cavity, and the housing includes a first board; and a separating member, located in the first accommodating cavity and spaced apart from the first board, where the mainboard is disposed between the first board and the separating member, and the first board and the separating member are both metal members.

In the opto-mechanical system in some embodiments of this application, both the separating member and the first board are designed to be formed by a metal member, which can form an electromagnetic shielding structure of the mainboard, to shield electromagnetic radiation outside the separating member and the first board from affecting the mainboard, and also prevents the mainboard from affecting outside of the separating member and the first board during operation. In some embodiments, with the electromagnetic shielding structure formed by the separating member and the first board, electromagnetic interference between the mainboard and internal assemblies such as the light emission assembly and the light receiving assembly can be avoided, and normal operation of the mainboard is ensured.

### BRIEF DESCRIPTION OF DRAWINGS

Exemplary embodiments of this application are described with reference to the accompanying drawings, to more expressly illustrate the foregoing and other objectives, features, and advantages of this application. In the exemplary embodiments of this application, the same reference numerals generally represent the same components.

FIG. 1 is a cross-sectional view of an opto-mechanical system according to Embodiment 1 of this application;

FIG. 2 is an exploded schematic view of the opto-mechanical system shown in FIG. 1;

FIG. 3 is a schematic structural diagram of the light emission assembly, the light receiving assembly, the light scanning assembly, and the separating member in the opto-mechanical system shown in FIG. 1;

FIG. 4 is an exploded schematic view of the light receiving assembly in the opto-mechanical system shown in FIG. 1:

FIG. 5 is an exploded schematic view of a separating member in the opto-mechanical system shown in FIG. 1;

FIG. 6 is a schematic structural diagram of an opto-mechanical system according to Embodiment 2 of this application;

FIG. 7 is a schematic structural diagram of an opto-mechanical system according to Embodiment 3 of this application:

FIG. 8 is a schematic structural diagram of an opto-mechanical system according to Embodiment 4 of this application;

FIG. 9 is a schematic structural diagram of an opto-mechanical system according to Embodiment 5 of this application;

FIG. 10 is a schematic structural diagram of an opto-mechanical system according to Embodiment 6 of this application;

FIG. 11 is a schematic structural diagram of an opto-mechanical system according to Embodiment 7 of this application:

FIG. 12 is a schematic structural diagram of an opto-mechanical system according to Embodiment 8 of this application;

FIG. 13 is a schematic top view of the light emission assembly, the light receiving assembly, the light scanning assembly, and the housing in the opto-mechanical system shown in FIG. 1;

FIG. 14 is a schematic three-dimensional cross-sectional view of a partial structure in the opto-mechanical system shown in FIG. 1:

FIG. 15 is a schematic three-dimensional view of an extinction fin in the opto-mechanical system shown in FIG. 1; and

FIG. 16 is an enlarged schematic view of a structure at position A in FIG. 1.

Reference signs: 1—opto-mechanical system; 10—light emission assembly; 12—emission board; 121—first board surface; 122—second board surface; 13—emission shielding cover; 131—second through hole; 20—light receiving assembly; 21—light receiver; 22—receiving board; 221—third board surface; 222—fourth board surface; 23—receiving shielding cover; 231—first through hole; 232—first shielding sub-cover; 233—second shielding sub-cover; 24—shielding ring; 25—light filter; 261—first stray light channel; 262—second stray light channel; 30—light scanning assembly; 31—first light scanning element; 311—galvanometer; 3111—first reflection surface; 32—second light scanning element; 321—rotating mirror; 3211—second reflection surface; 40—first light path changing assembly; 41—first reflection element; 411—one first reflector; 412—another first reflection element; 50—second light path changing assembly; 51—second reflection element; 511—one second reflection element; 512—another second reflection element; 60—light collimating assembly; 61—fast-axis collimating lens; 62—slow-axis collimating lens; 70—separating member; 71—emission light channel; 711—first light inlet; 712—first light outlet; 713—first sub-channel; 714—third sub-channel; 72—echo light channel; 721—second light inlet; 722—second light outlet; 723—second sub-channel; 724—fourth sub-channel; 73—surrounding plate; 731—second accommodating cavity; 732—first plate; 7321—first surface; 7322—first sub-surface; 7323—second sub-surface; 7324—avoidance space; 733—second plate; 734—third plate; 735—fourth plate; 74—partition; 75—first cover plate; 76—second cover plate; 80—housing; 81—first accommodating cavity; 82—first board; 821—inner board surface; 8211—first region; 8212—second region: 8213—third region; 8214—fourth region; 83—box; 84—cover; 85—baffle; 91—mainboard; 911—fifth board surface; 912—sixth board surface; 92—electronic control board; 93—interface board; 941—first heat conduction member; 942—second heat conduction member; 9421—first heat conduction sub-member; 9422—second heat conduction sub-member; 9423—third heat conduction sub-member; 943—light blocking plate; 944—extinction fin; 9441—extinction tube; 9442—support plate; m—first linear direction; n—second linear direction; p—first rotation axis; and q—second rotation axis.

### DETAILED DESCRIPTION

To make objectives, technical solutions, and advantages of the present application clearer, embodiments of the present application are described in further detail below with reference to the drawings.

When the following description refers to the drawings, unless otherwise indicated, the same numbers in different drawings indicate the same or similar elements. The implementation described in the following exemplary embodiments do not represent all implementations consistent with the present application. On the contrary, the implementation is merely examples of devices and methods consistent with some aspects of the present application as detailed in the appended claims.

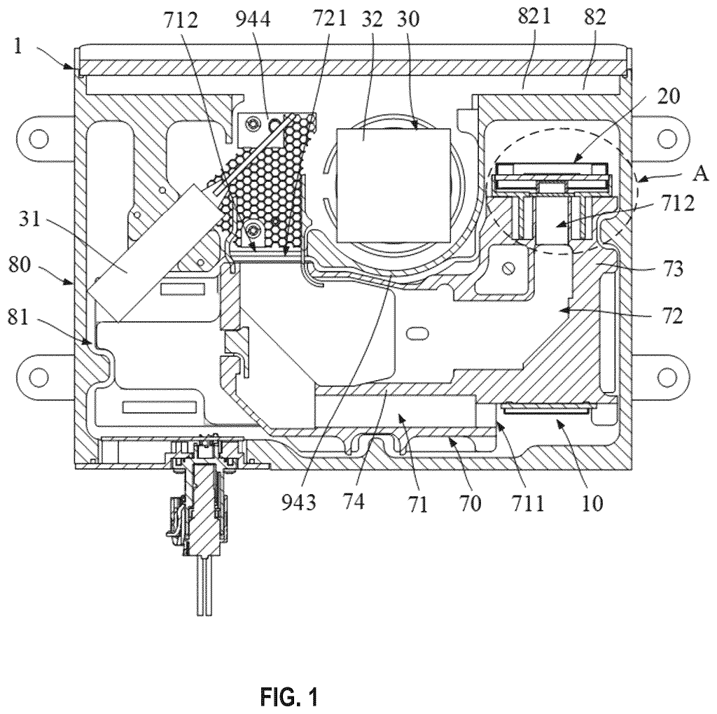

Referring to FIG. 1, some embodiments of this application provide an opto-mechanical system 1. The opto-mechanical system 1 may be a LiDAR or the like. The opto-mechanical system 1 may be used for functions such as navigation, obstacle avoidance, obstacle recognition, ranging, speed measurement, and autonomous driving of products such as a vehicle, a robot, a transport vehicle, and a patrol vehicle. This is not limited in the embodiments of this application.

In an example, the opto-mechanical system 1 includes a light emission assembly 10 and a light receiving assembly 20, where the light emission assembly 10 is configured to emit an emission light signal to a target object, and the light receiving assembly 20 is configured to receive an echo light signal reflected by the target object. The echo light signal is compared with the emission light signal, and after appropriate processing, information such as a distance between the opto-mechanical system and a target object can be obtained.

Herein, the target object is any object within a detection range of the opto-mechanical system 1. It can be understood that the target object may be an object of interest defined by a user. This application imposes no limitation on the target object.

In some embodiments of this application, the opto-mechanical system 1 further includes a light scanning assembly 30. The light scanning assembly 30 can be configured to emit, in multiple directions, the emission light signal emitted by the light emission assembly 10. The light scanning assembly 30 can be configured to transmit the echo light signal in multiple directions to the light receiving assembly 20, to improve a detection angle of view of the opto-mechanical system 1 and measure distances between the target object and the opto-mechanical system 1 at different azimuths.

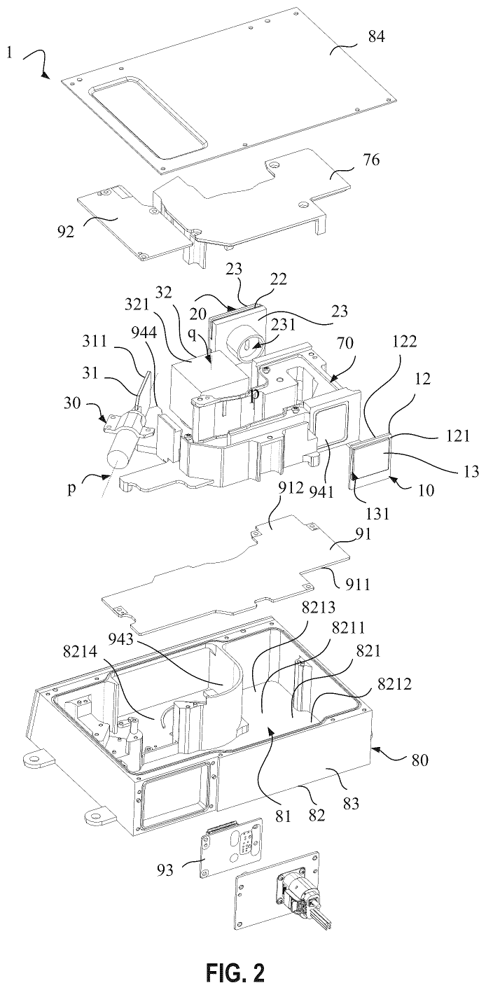

Referring to FIG. 2, the opto-mechanical system 1 further includes a mainboard 91 and an electronic control board 92. The mainboard 91 is electrically connected to the light emission assembly 10 and configured to control the light emission assembly 10 to emit an emission light signal to the target object, and the mainboard 91 is electrically connected to the light receiving assembly 20 and configured to control the light receiving assembly 20 to receive the echo light signal reflected by the target object. The electronic control board 92 is electrically connected to the light scanning assembly 30 and configured to control a movement of the light scanning assembly 30, to emit the emission light signal in multiple directions and/or receive the echo light signal in multiple directions.

In some embodiments of this application, the electronic control board 92 is disposed independently of the mainboard 91 and electrically connected to the mainboard 91. Compared with integrated disposition, the heat dissipation performance of the opto-mechanical system 1 can be improved, and when the product needs iteration or is inconsistent with a requirement of a customer, only the electronic control board 92 needs to be disassembled and replaced, which reduces replacement cost and improves replacement efficiency.

In some embodiments, the electronic control board 92 and the mainboard 91 can be respectively arranged on two opposite sides of the light scanning assembly 30 to increase a distance between the electronic control board 92 and the mainboard 91, and to improve the heat dissipation performance of the opto-mechanical system 1.

In some embodiments, the light scanning assembly 30 may include a first light scanning element 31 and a second light scanning element 32. The emission light signal is sequentially transmitted by the first light scanning element 31 and the second light scanning element 32 to the target object, and the echo light signal is sequentially transmitted by the second light scanning element 32 and the first light scanning element 31 to the light receiving assembly 20. In some embodiments, the electronic control board 92 may be electrically connected to the first light scanning element 31 and configured to control a movement of the first light scanning element 31, and the electronic control board 92 may be electrically connected to the second light scanning element 32 and configured to control a movement of the second light scanning element 32, to combine the first light scanning element 31 and the second light scanning element 32 and emit the emission light signal in multiple directions and/or receive the echo light signal in multiple directions. In some embodiments, the electronic control board 92 may be disposed to correspond to the first light scanning element 31.

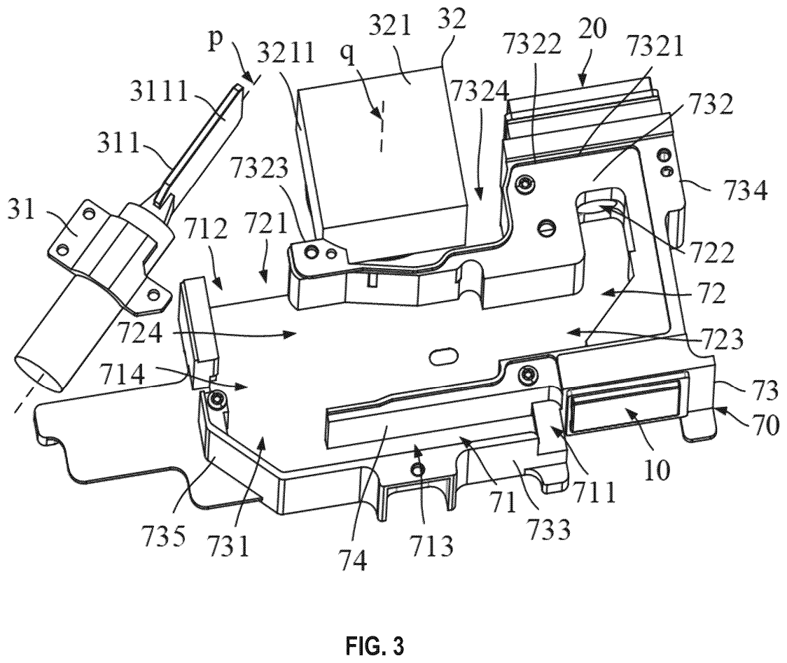

In some embodiments, both the first light scanning element 31 and the second light scanning element 32 can have a reflection structure. For example, the first light scanning element 31 can be a galvanometer or a rotating mirror, and the second light scanning element 32 can be a galvanometer or a rotating mirror. In some embodiments, the first light scanning element 31 includes a galvanometer 311, and the second light scanning element 32 includes a rotating mirror 321. In some embodiments, referring to FIG. 2 and FIG. 3, the galvanometer 311 has a first reflection surface 3111 for transmitting an emission light signal and/or an echo light signal, the electronic control board 92 may be electrically connected to the galvanometer 311 and configured to control the galvanometer 311 to rotate around the first rotation axis p, and the first reflection surface 3111 faces the second light scanning element 32. The rotating mirror 321 has multiple second reflection surfaces 3211 for transmitting the emission light signal and/or the echo light signal, the electronic control board 92 may be electrically connected to the rotating mirror 321 and configured to control the rotating mirror 321 to rotate around the second rotation axis q, and the multiple second reflection surfaces 3211 are arranged around a periphery of the second rotation axis q, so that at least one second reflection surface 3211 faces the first reflection surface 3111 of the first light scanning element 31 when the rotating mirror 321 rotates around the second rotation axis q.

Herein, the reflection surface (for example, the first reflection surface 3111 and the second reflection surface 3211) can reflect the light signal (for example, the emission light signal and the echo light signal), and change the transmission direction of the light signal, so that the light signal can be smoothly transmitted backward.

In some embodiments, the first rotation axis p may be perpendicular to the second rotation axis q. Herein, rotation of the galvanometer 311 around the first rotation axis p can implement adjustment of an angle of view in a direction, and rotation of the rotating mirror 321 around the second rotation axis q can implement adjustment of the angle of view in another direction. In addition, when the first rotation axis p is perpendicular to the second rotation axis q, adjustment directions of the two angles of view may be perpendicular to each other. For example, the rotation of the galvanometer 311 around the first rotation axis p can implement adjustment in a vertical angle of view, and the rotation of the rotating mirror 321 around the second rotation axis q can implement adjustment in a horizontal angle of view. In some embodiments of this application, the rotating mirror 321 can implement scanning at a horizontal angle of view of 120°, and the galvanometer 311 can implement scanning at a vertical angle of view of 25°, to complete scanning of space at a full angle of view of 120°×25°.

In some embodiments, referring to FIG. 2 again, the light emission assembly 10 includes a light emitter (not shown in the figure) and an emission board 12, the light emitter is mounted on the emission board 12 and electrically connected to the emission board 12, and the emission board 12 is disposed independently of the mainboard 91 and electrically connected to the mainboard 91. In some embodiments, the light receiving assembly 20 includes a light receiver 21 and a receiving board 22, the light receiver 21 is mounted on the receiving board 22 and electrically connected to the receiving board 22, and the receiving board 22 is disposed independently of the mainboard 91 and electrically connected to the mainboard 91. The emission board 12, the receiving board 22 and the mainboard 91 are disposed independently, which can further improve the heat dissipation performance of the opto-mechanical system 1 and facilitate an operation such as replacement of the emission board 12 and the receiving board 22.

In some embodiments, the opto-mechanical system 1 further includes an interface board 93, the interface board 93 is disposed independently of the mainboard 91 and electrically connected to the mainboard 91. The interface board 93 is configured to provide a power supply signal for at least one of the light emission assembly 10, the light receiving assembly 20, and the light scanning assembly 30. Because this may be inconsistent with an interface requirement of a user, the interface board 93 is disposed independently of the mainboard 91, which can facilitate replacement or repair of the interface board 93 and further improve the heat dissipation performance of the opto-mechanical system 1.

In some embodiments, the mainboard 91, the electronic control board 92, the emission board 12, the receiving board 22 and the interface board 93 are disposed independently of each other, so that only a part of a board needs to be updated and redesigned when the product needs iteration or is inconsistent with a requirement of the user, thereby saving a cost and time and implementing a better heat dissipation effect.

In some embodiments, the opto-mechanical system 1 further includes a housing 80, the housing 80 forms a first accommodating cavity 81, and the light emission assembly 10, the light receiving assembly 20, a light scanning assembly 30, the mainboard 91, the electronic control board 92, the interface board 93 and the like may all be provided in the first accommodating cavity 81 of the housing 80.

In some embodiments, the housing 80 may include a box 83 and a cover 84 connected to the box 83, the box 83 and the cover 84 jointly define a first accommodating cavity 81, the electronic control board 92 can be disposed close to the cover 84, and the mainboard 91 can be disposed close to a bottom of the box 83. Further, a visible window corresponding to the electronic control board 92 may be disposed on the cover 84, so that staff can check an operation status of the electronic control board 92 and find a fault in a timely manner when the fault occurs.

To facilitate heat dissipation of components such as the light emission assembly 10, the light receiving assembly 20, the mainboard 91, the electronic control board 92 and the interface board 93 in the first accommodating cavity 81 during use and ensure the normal operation of the opto-mechanical system 1, in some embodiments, a first heat conduction member 941 may be disposed between the emission board 12 of the light emission assembly 10 and the housing 80; a second heat conduction member 942 may be disposed between the receiving board 22 of the light receiving assembly 20 and the housing 80; a fourth heat conduction member (not shown in the figure) may be disposed between the mainboard 91 and the housing 80; a fifth heat conduction member (not shown in the figure) may be disposed between the electronic control board 92 and the housing 80; and/or a sixth heat conduction member (not shown in the figure) may be disposed between the interface board 93 and the housing 80. Therefore, heat generated by the light emission assembly 10, the light receiving assembly 20, the mainboard 91, the electronic control board 92 and the interface board 93 during use can be transferred to the housing 80 through corresponding heat conduction members and further dissipated outside.

It should be noted that the emission board 12 of the light emission assembly 10, the receiving board 22 of the light receiving assembly 20, the mainboard 91, the electronic control board 92 and the interface board 93 can be directly connected to the housing 80 through the corresponding heat conduction members, or can be connected to the housing 80 through middleware, which is not limited in this application. In some embodiments of this application, the mainboard 91, the electronic control board 92 and the interface board 93 are directly connected to the housing 80 through the corresponding heat conduction members, and the emission board 12 and the receiving board 22 are connected to the housing 80 through middleware. More detailed description is provided below.

In some embodiments, referring to FIG. 2 and FIG. 3, the opto-mechanical system 1 further includes a separating member 70, and the separating member 70 forms an emission light channel 71 and an echo light channel 72. The emission light channel 71 is configured to transmit the emission light signal, thereby reducing or even avoiding interference of stray light on the emission light signal. The echo light channel 72 is configured to transmit the echo light signal, thereby reducing or even avoiding interference of stray light on the echo light signal.

In some embodiments, the emission light channel 71 has a first light inlet 711 and a first light outlet 712. The light emission assembly 10 is disposed to correspond to the first light inlet 711, and the light scanning assembly 30 is disposed to correspond to the first light outlet 712, so that the emission light signal emitted by the light emission assembly 10 can enter the emission light channel 71 in a timely manner and reach the light scanning assembly 30 after being transmitted in the emission light channel 71, thereby reducing or even avoiding interference of the stray light. The echo light channel 72 has a second light inlet 721 and a second light outlet 722, the light scanning assembly 30 is disposed to correspond to the second light inlet 721, and the light receiving assembly 20 is disposed to correspond to the second light outlet 722, so that the echo light signal transmitted by the light scanning assembly 30 can enter the echo light channel 72 in a timely manner and reach the light receiving assembly 20 after being transmitted in the echo light channel 72, thereby reducing or even avoiding interference of the stray light.

In some embodiments, both the light emission assembly 10 and the light receiving assembly 20 can be connected to the separating member 70, a third heat conduction member (not shown in the figure) can be provided between the separating member 70 and the housing 80, and the emission board 12 and the receiving board 22 can be connected to the housing 80 through the separating member 70, so that heat generated by the emission board 12 and the receiving board 22 can be transferred to the separating member 70, then transferred to the housing 80 via the separating member 70, and then dissipated outside.

In some embodiments, the emission board 12 has a first board surface 121 and a second board surface 122 facing away from the first board surface 121, the first board surface 121 is mounted with the light emitter, and the first heat conduction member 941 is disposed between the second board surface 122 and the separating member 70, so that heat generated by the emission board 12 can be transferred to the separating member 70 through the first heat conduction member 941, then transferred to the housing 80 through the separating member 70, and then dissipated outside. In some embodiments, the first heat conduction member 941 may include a graphene layer and a heat conduction gel layer. In some embodiments, the emission board 12 includes a substrate and a conductive layer disposed on the substrate, and the substrate can be a plate with better heat dissipation performance. For example, the substrate can be a ceramic plate.

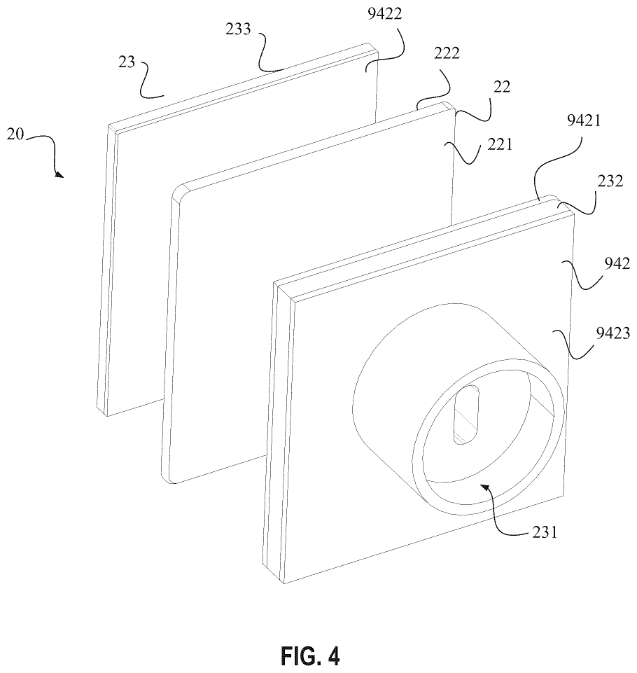

In some embodiments, referring to FIG. 2 and FIG. 4, the light receiving assembly 20 includes a receiving shielding cover 23 covering the light receiver 21 and the receiving board 22, the receiving shielding cover 23 is provided with a first through hole 231 corresponding to the light receiver 21, the receiving board 22 has a third board surface 221 and a fourth board surface 222 facing away from the third board surface 221, and the third board surface 221 is mounted with the light receiver 21. A first heat conduction sub-member 9421 is disposed between the third board surface 221 and the receiving shielding cover 23, a second heat conduction sub-member 9422 is disposed between the fourth board surface 222 and the receiving shielding cover 23, and a third heat conduction sub-member 9423 is disposed between the receiving shielding cover 23 and the separating member 70. The second heat conduction member 942 includes the first heat conduction sub-member 9421, the second heat conduction sub-member 9422, and the third heat conduction sub-member 9423, so that heat generated by the receiving board 22 can be transferred to the receiving shielding cover 23 and the separating member 70. Heat on the separating member 70 can be further transferred to the housing 80, and then dissipated outside. In some embodiments, both the first heat conduction sub-member 9421 and the second heat conduction sub-member 9422 may include a heat conduction gel layer, and the third heat conduction sub-member 9423 includes the graphene layer and the heat conduction gel layer.

In some embodiments, the receiving shielding cover 23 may include a first shielding sub-cover 232 on a side on which the third board surface 221 is located and a second shielding sub-cover 233 on a side on which the fourth board surface 222 is located, and both the first shielding sub-cover 232 and the second shielding sub-cover 233 are connected to the receiving board 22.

In some embodiments, each of the third heat conduction member, the fourth heat conduction member, the fifth heat conduction member, and the sixth heat conduction member may include the heat conduction gel layer.

In some embodiments, referring to FIG. 3 again, the separating member 70 includes a surrounding plate 73 and a partition 74. The surrounding plate 73 is located in the first accommodating cavity 81, and the surrounding plate 73 forms a second accommodating cavity 731 that communicates with a first light inlet 711, a first light outlet 712, a second light inlet 721, and a second light outlet 722. The partition 74 is located in the second accommodating cavity 731 and divides the second accommodating cavity 731 into an emission light channel 71 and an echo light channel 72, and at least part of the emission light channel 71 and at least part of the echo light channel 72 can be separated by the partition 74, to improve independence of the emission light channel 71 and the echo light channel 72, and to reduce crosstalk between the emission light signal and the receiving light signal.

It should be noted that a part of the emission light channel 71 and a part of the echo light channel 72 can be separated by the partition 74, or the entire emission light channel 71 and the entire echo light channel 72 can be separated by the partition 74. This is not limited in some embodiments of this application and can be flexibly adjusted with reference to a specific requirement.

In some embodiments, when the part of the emission light channel 71 is separated from the part of the echo light channel 72, one end of the partition 74 can be connected to a part of the surrounding plate 73 that is located between the first light inlet 711 and the second light outlet 722, and another end can be located in the second accommodating cavity 731 and spaced apart from the surrounding plate 73, so that a first sub-channel 713 in the emission light channel 71 that is closer to the light emission assembly 10 is separated by the partition 74 from the second sub-channel 723 in the echo light channel 72 that is closer to the light receiving assembly 20, to prevent the emission light signal emitted by the light emission assembly 10 from interfering with the echo light signal received by the light receiving assembly 20. In addition, a third sub-channel 714 in the emission light channel 71 that is farther away from the light emission assembly 10 is communicated with a fourth sub-channel 724 in the echo light channel 72 that is farther away from the light receiving assembly 20. In some embodiments, the first light outlet 712 can be communicated with the second light inlet 721.

In some embodiments, when the entire emission light channel 71 is separated from the entire echo light channel 72, one end of the partition 74 can be connected to a part of the surrounding plate 73 that is located between the second light inlet 721 and the first light outlet 712, and another end can be connected to a part of the surrounding plate 73 that is located between the first light outlet 712 and the second light inlet 721, so that the entire emission light channel 71 and the entire echo light channel 72 are separated by the partition 74.

In some embodiments, the surrounding plate 73 may include a first plate 732. A first light outlet 712 and a second light inlet 721 are formed on the first plate 732. The first plate 732 is recessed toward the second accommodating cavity 731 to form avoidance space 7324, and the second light scanning element 32 is disposed in the avoidance space 7324, so that a structure of the opto-mechanical system 1 is more compact and a miniaturized design of the opto-mechanical system 1 is achieved.

In some embodiments, the surrounding plate 73 includes a second plate 733, a third plate 734, and a fourth plate 735. The second plate 733 is spaced apart from the first plate 732. The third plate 734 is connected to the first plate 732 and extends toward the second plate 733. The fourth plate 735 is connected to the second plate 733 and extends toward the first plate 732. The fourth plate 735, the first plate 732, the second plate 733, and the third plate 734 encircle and form the second accommodating cavity 731. The first light inlet 711 is disposed at a position of the second plate 733 that is closer to the third plate 734, the second light outlet 722 is disposed at a position of the first plate 732 that is closer to the third plate 734, and the partition 74 is connected to the third plate 734 and spaced apart from both the second plate 733 and the first plate 732. The surrounding plate 73 in some embodiments of this application is roughly enclosed by four plates, has a relatively simple structure and is easy to manufacture.

It should be noted that the first plate 732, the second plate 733, the third plate 734, and the fourth plate 735 may be in any shape. This is not limited in the embodiments of this application.

In some embodiments, the light emission assembly 10 is attached to and connected to a surface of the partition 74 that faces away from the first plate 732, to enhance a connection area between the light emission assembly 10 and the separating member 70 and improve connection stability of the light emission assembly 10 and the separating member 70.

In some embodiments, both the second light inlet 721 and the first light outlet 712 are located on and communicated with the first plate 732, to simplify a structural design of the separating member 70. In some embodiments, the first light outlet 712 can be located at a position of the first plate 732 that is closer to the fourth plate 735, and the first light inlet 711 is disposed at a position of the second plate 733 that is closer to the third plate 734, which can extend a distance between the first light inlet 711 and the first light outlet 712, extend a transmission path of the emission light signal, reduce a divergence angle, improve a ranging capability, and reduce light crosstalk. In some embodiments, the second light inlet 721 can be located at a position of the first plate 732 that is closer to the fourth plate 735, and the second light outlet 722 is disposed at a position of the first plate 732 that is closer to the third plate 734, which can extend a distance between the second light inlet 721 and the second light outlet 722, extend a transmission path of the echo light signal, and improve ranging capability.

The first plate 732 has a first surface 7321 facing away from the second plate 733. The first surface 7321 includes a first sub-surface 7322 closer to the third plate 734 and a second sub-surface 7323 closer to the fourth plate 735. The second sub-surface 7323 is between the first sub-surface 7322 and the second plate 733, so that avoidance space 7324 for disposing the second light scanning element 32 is formed between the first sub-surface 7322 and the second sub-surface 7323. The first light outlet 712 and the second light inlet 721 are disposed to correspond to the second sub-surface 7323, and the second light outlet 722 is disposed to correspond to the first sub-surface 7322.

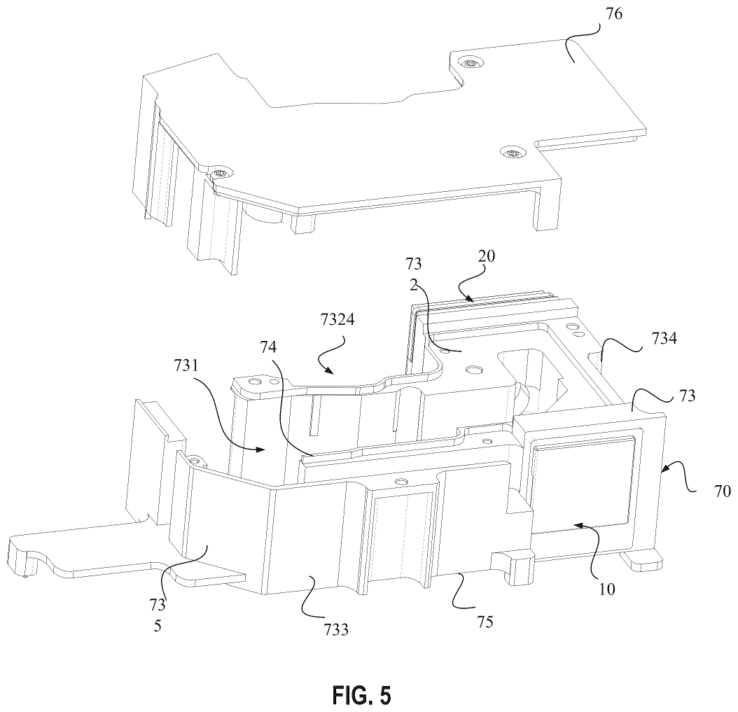

In some embodiments, referring to FIG. 5, the separating member 70 further includes a first cover plate 75 and a second cover plate 76. The first cover plate 75 and the second cover plate 76 are respectively on two opposite sides of the surrounding plate 73 and connected to the surrounding plate 73, to form the second accommodating cavity 731 together with the surrounding plate 73, so that light-shielding performance of the second accommodating cavity 731 is better and the interference of the stray light on the emission light signal and the echo light signal is reduced. In some embodiments, a connection between the first cover plate 75, the second cover plate 76, and the surrounding plate 73 can be any connection, for example, a snap-fit connection or an adhesive connection. This is not limited in the embodiments of this application. In some embodiments, the first cover plate 75 and the surrounding plate 73 can directly form an integrated structure, and the snap-fit connection of the second cover plate 76 and the surrounding plate 73 can be achieved through a structure such as a slot or a pin.

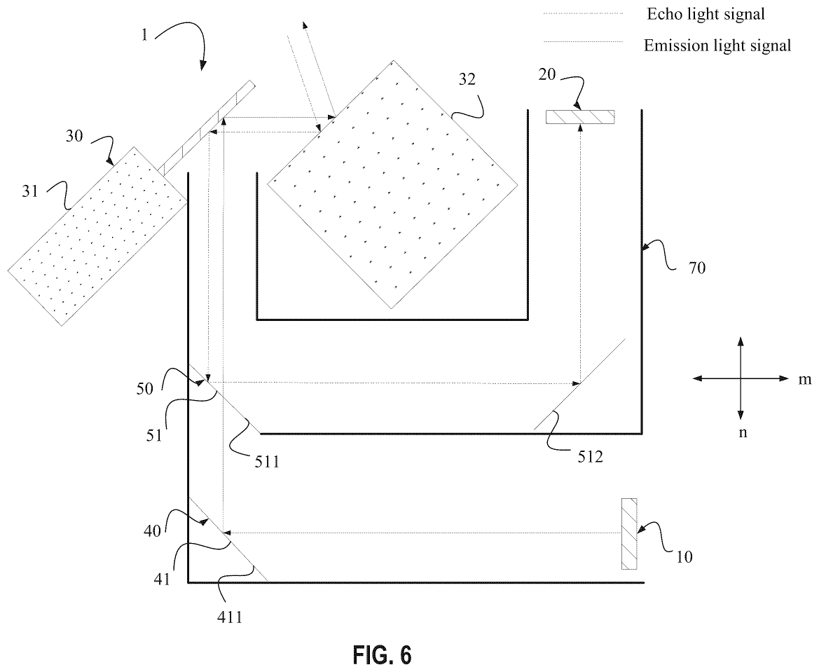

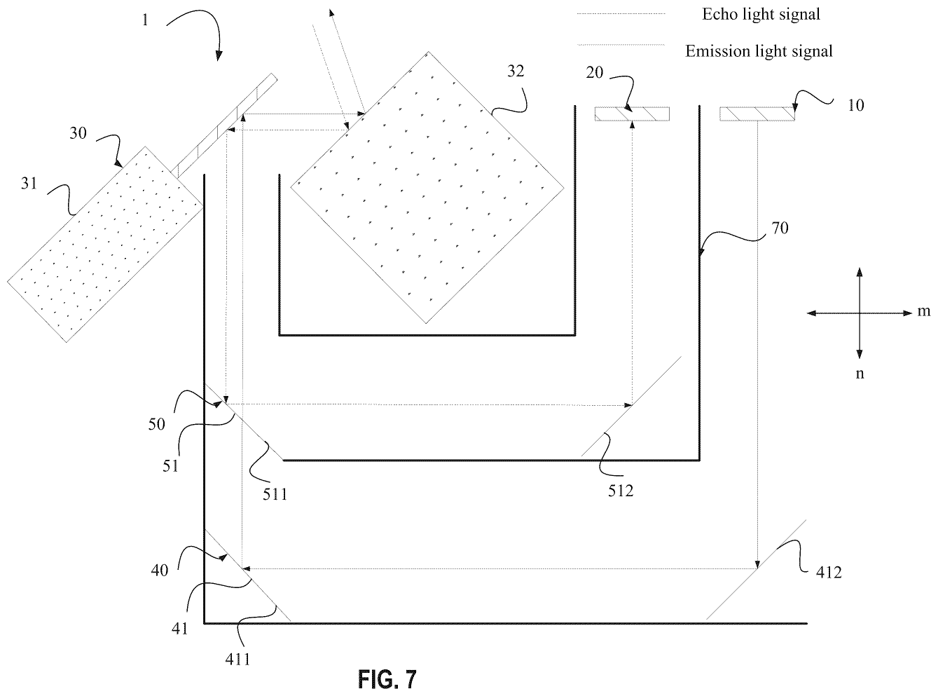

In some embodiments, referring to FIG. 6 and FIG. 7, along the first linear direction m, the second light scanning element 32 is between the first light scanning element 31 and the light emission assembly 10. The emission light signal is emitted through the second light scanning element 32. The second light scanning element 32 is between the first light scanning element 31 and the light emission assembly 10, and an outgoing position of the emission light signal can be roughly in the middle of the opto-mechanical system 1, which facilitates calibration of the opto-mechanical system 1 and symmetry of a short-distance point cloud.

In some embodiments, along the first linear direction m, the second light scanning element 32 is between the first light scanning element 31 and the light emission assembly 10, and therefore, a transmission path of the emission light signal sent by the light emission assembly 10 from the light emission assembly 10 to the first light scanning element 31 can be extended, which facilitates a reduction in a divergence angle and improves ranging capability of the opto-mechanical system 1. In some embodiments, the opto-mechanical system 1 satisfies the following conditional formula 1: SNR∝\sqrt{A_{rec}/A_{FOV}}, where SNR is a signal-to-noise ratio of the echo light signal, Pt is total emission power, Arec is a receiving cross section, and AFOV is a receiving angle of view. It can be learned from the foregoing conditional formula 1 that a value of the receiving angle of view AFOV determines magnitude of noise in the echo light signal. The larger the receiving angle of view AFOV, the greater the received noise. Therefore, it is necessary to reduce the receiving angle of view AFOV. In addition, the receiving angle of view AFOV is related to the size of a light receiver 21 in the light receiving assembly 20 and focal length of a receiving lens. For example, if the divergence angle δθ is 0.2°×0.2°, the size of the light receiver 21 or the focal length of the receiving lens can be customized, so that the receiving angle of view AFOV is slightly greater than 0.2°×0.2°, thereby ensuring that all the echo light signals can be received by the light receiver 21 and avoiding loss of light signal. In the following conditional formula 2 of the opto-mechanical system 1: δθ=L/f, where δθ is a divergence angle of the emission light signal. L is a light emission area of the light emission assembly 10, and f is focal length of an emission lens in the light emission assembly 10. It can be learned from the foregoing conditional formula 2 that a telephoto system can reduce the divergence angle δθ. With the reduction in the divergence angle δθ, the receiving angle of view AFOV can be made smaller, noise is reduced, and the detection capability of the opto-mechanical system 1 is improved. In addition, the transmission path of the emission light signal is extended, and crosstalk between channels can be further reduced.

It should be noted that along the first linear direction m, the second light scanning element 32 is between the first light scanning element 31 and the light emission assembly 10. The emission light signal sent by the light emission assembly 10 passes through the first light scanning element 31 and the second light scanning element 32 in sequence, the emission light signal emitted by the light emission assembly 10 may be interfered with by the second light scanning element 32 when reaching the first light scanning element 31. In this regard, the opto-mechanical system 1 in some embodiments of this application may include a first light path changing assembly 40. Along the transmission path of the emission light signal, the first light path changing assembly 40 is disposed between the light emission assembly 10 and the first light scanning element 31. With the first light path changing assembly 40 disposed, the transmission path of the emission light signal emitted by the light emission assembly 10 changes from a transmission path of the first light scanning element 31 and the second light scanning element 32 in sequence to a transmission path of the first light path changing assembly 40, the first light scanning element 31, and the second light scanning element 32 in sequence, which can avoid interference from the second light scanning element 32 when the emission light signal is transmitted from the light emission assembly 10 to the first light path changing assembly 40 and w % ben the emission light signal is transmitted from the first light path changing assembly 40 to the first light scanning element 31, thereby ensuring normal transmission of the emission light signal.

In some embodiments, the first light path changing assembly 40 includes at least one first reflection element 41, and the transmission path of the emission light signal can be deflected by the reflection surface of the first reflection element 41, to ensure that the emission light signal can be smoothly transmitted to the first light scanning element 31.

It should be noted that, in foregoing case that along the first linear direction m, the second light scanning element 32 is between the first light scanning element 31 and the light emission assembly 10. This may mean that the second light scanning element 32, the first light scanning element 31, and the light emission assembly 10 are roughly in the same line, and the second light scanning element 32 is between the first light scanning element 31 and the light emission assembly 10. Or this may mean that projection of the second light scanning element 32, the first light scanning element 31, and the light emission assembly 10 on the same line satisfies that the second light scanning element 32 is between the first light scanning element 31 and the light emission assembly 10, to reduce an assembly accuracy requirement of the second light scanning element 32, the first light scanning element 31, and the light emission assembly 10, and to reduce assembly difficulty.

In some embodiments, for a case that the light emission assembly 10 may be on aside of the second light scanning element 32 that faces away from the target object along the second linear direction n, refer to FIG. 6. For a case that the light emission assembly 10 may be on a side of the second light scanning element 32 that is closer to the target object, refer to FIG. 7. The second linear direction n intersects with the first linear direction m. Referring to FIG. 6, when the light emission assembly 10 is on a side of the second light scanning element 32 that is farther away from the target object along the second linear direction n, in some embodiments, in all first reflection elements 41 of the first light path changing assembly 40, one first reflection element 411 may be distributed along the second linear direction n together with the first light scanning element 31 and may be on a side of the first light scanning element 31 that is farther away from the target object. In some embodiments of this application, one first reflection element 411 is numbered with 411, to distinguish the number from a number 41 of another first reflection element 41 when the first light path changing assembly 40 includes multiple first reflection elements 41. It should be noted that, at this time, the first light path changing assembly 40 may include only one first reflection element 41.

Referring to FIG. 7, when the light emission assembly 10 is on a side of the second light scanning element 32 that is closer to the target object along the second linear direction n, in some embodiments, in all the first reflection elements 41, one first reflection element 411 may be distributed along the second linear direction n together with the first light scanning element 31 and may be on a side of the first light scanning element 31 that is farther away from the target object. Another first reflection element 412 may be distributed along the second linear direction n together with the second light scanning element 32 and may be on a side of the second light scanning element 32 that is farther away from the target object. And along the transmission path of the emission light signal, a still another first reflection element 412 is between the light emission assembly 10 and the first reflection element 411. In some embodiments of this application, one first reflection element is numbered with 411, and another first reflection element is numbered with 412 for distinction.

It should be noted that the first reflection element 41 may be replaced with a refraction element or the like, and a specific structural design of the first light path changing assembly 40 is not limited in the embodiments of this application.

In some embodiments, along the first linear direction m, the second light scanning element 32 is between the first light scanning element 31 and the light receiving assembly 20. The echo light signal is emitted to the opto-mechanical system 1 through the second light scanning element 32. The second light scanning element 32 is between the first light scanning element 31 and the light receiving assembly 20. An incident position of the echo light signal can be roughly in the middle of the opto-mechanical system 1, which facilitates calibration of the opto-mechanical system 1 and symmetry of a short-distance point cloud.

In some embodiments, along the first linear direction m, the second light scanning element 32 is between the first light scanning element 31 and the light receiving assembly 20. Therefore, a transmission path of the echo light signal from the first light scanning element 31 to the light receiving assembly 20 can be extended, which facilitates a reduction in noise received by the light receiver 21 and improves the ranging capability of the opto-mechanical system 1. In some embodiments, due to processing tolerance or cost, a photosensitive surface of the light receiver 21 is usually about 0.5 mm. For a system with a small divergence angle, a design of short focal length makes a receiving angle of view corresponding to the 0.5 mm photosensitive surface relatively redundant, which increases received noise. However, the focal length of the opto-mechanical system 1 in this application can be 50 mm, to reduce the receiving angle of view. Disposing the second light path changing assembly 50 and/or the first light path changing assembly 40 can improve the space utilization rate of an entire device and make a structure thereof more compact.

When the opto-mechanical system 1 in the embodiments of this application is applied to autonomous driving, a detection capability of 250 m@10% and a resolution capability of less than 0.1° can be achieved, thereby meeting a requirement of high-precision imaging.

It should be noted that along the first linear direction m, the second light scanning element 32 is between the first light scanning element 31 and the light receiving assembly 20. The echo light signal passes through the second light scanning element 32 and the first light scanning element 31 in sequence to reach the light receiving assembly 20, and the echo light signal may be interfered with by the second light scanning element 32 when being transmitted from the first light scanning element 31 to the light receiving assembly 20. In this regard, the opto-mechanical system 1 in some embodiments of this application may include a second light path changing assembly 50. Along the transmission path of the echo light signal, the second light path changing assembly 50 is disposed between the light receiving assembly 20 and the first light scanning element 31. With the second light path changing assembly 50 disposed, the transmission path of the echo light signal changes from a transmission path of passing through the first light scanning element 31 and then reaching the light receiving assembly 20 to a transmission path of passing through the first light scanning element 31 and the second light path changing assembly 50 and then reaching the light receiving assembly 20, which can avoid interference from the second light scanning element 32 when the echo light signal is transmitted from the first light scanning element 31 to the second light path changing assembly 50 and when the echo light signal is transmitted from the second light path changing assembly 50 to the light receiving assembly 20, thereby ensuring normal transmission of the echo light signal.

In some embodiments, the second light path changing assembly 50 includes at least one second reflection element 51, and the transmission path of the echo light signal can be deflected by a reflection surface of the second reflection element 51, to ensure that the echo light signal can be smoothly transmitted to the light receiving assembly 20.

It should be noted that, in foregoing case that along the first linear direction m, the second light scanning element 32 is between the first light scanning element 31 and the light receiving assembly 20. This may mean that the second light scanning element 32, the first light scanning element 31, and the light receiving assembly 20 are roughly in the same line, and the second light scanning element 32 is between the first light scanning element 31 and the light receiving assembly 20. Or this may mean that projection of the second light scanning element 32, the first light scanning element 31, and the light receiving assembly 20 on the same line satisfies that the second light scanning element 32 is between the first light scanning element 31 and the light receiving assembly 20, to reduce an assembly accuracy requirement of the second light scanning element 32, the first light scanning element 31, and the light receiving assembly 20, and to reduce assembly difficulty.

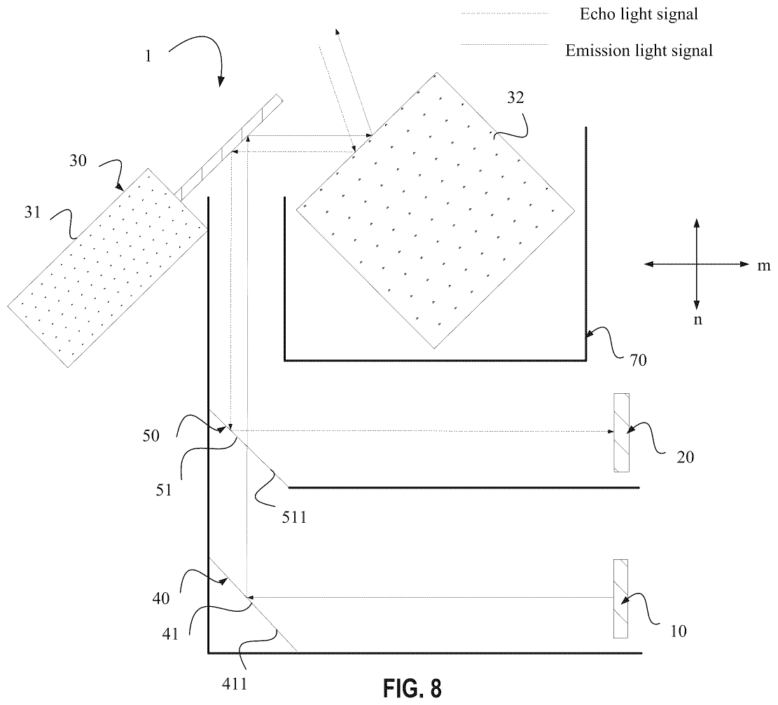

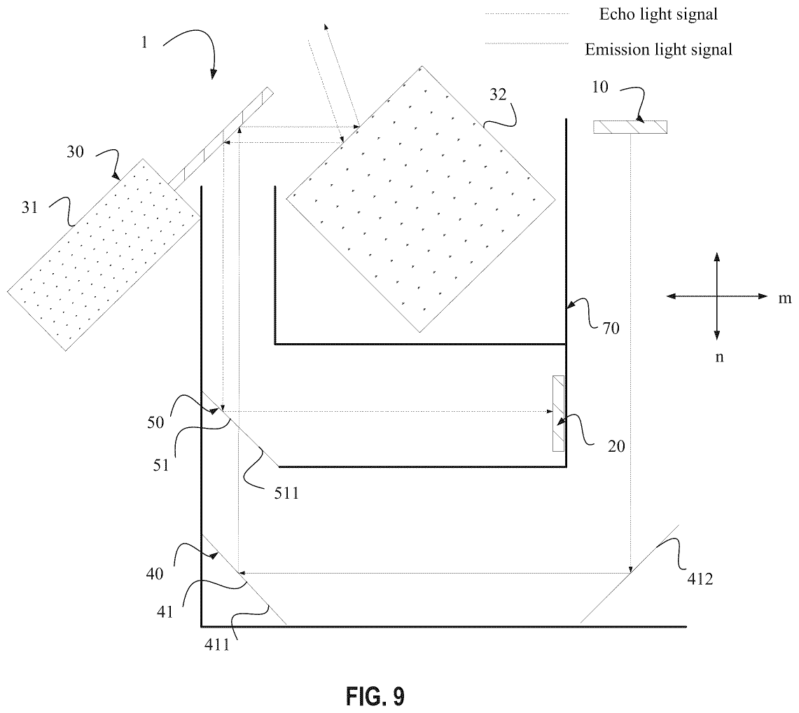

In some embodiments, for a case that the light receiving assembly 20 may be on a side of the second light scanning element 32 that is closer to the target object along the second linear direction n, refer to FIG. 6 and FIG. 7. For a case that the light receiving assembly 20 may be on a side of the second light scanning element 32 that is farther away from the target object, refer to FIG. 8 and FIG. 9. Referring to FIG. 6 and FIG. 7, when the light receiving assembly 20 is on a side of the second light scanning element 32 that is closer to the target object along the second linear direction n, in some embodiments, in all the second reflection elements 51 included in the second light path changing assembly 50, one second reflection element 511 may be distributed along the second linear direction n together with the first light scanning element 31 and may be on a side of the first light scanning element 31 that is farther away from the target object. Another second reflection element 512 may be distributed along the second linear direction n together with the second light scanning element 32 and may be on a side of the second light scanning element 32 that is farther away from the target object. And along the transmission path of the echo light signal, a still another second reflection element 512 is between the second reflection element 511 and the light receiving assembly 20. In some embodiments of this application, one second reflection element is numbered with 511, and another second reflection element is numbered with 512 for distinction.

Referring to FIG. 8 and FIG. 9, when the light receiving assembly 20 is on a side of the second light scanning element 32 that is farther away from the target object along the second linear direction n, in some embodiments, in all second reflection elements 51, one second reflection element 511 may be distributed along the second linear direction n together with the first light scanning element 31 and may be on a side of the first light scanning element 31 that is farther away from the target object. In some embodiments of this application, one second reflection element is numbered with 511, to distinguish the number 51 of another second reflection element when the second light path changing assembly 50 includes multiple second reflection elements. It should be noted that, at this time, the second light path changing assembly 50 may include only one second reflection element 51.

In some embodiments, when the second reflection element 511 is between the first reflection element 411 and the first light scanning element 31 along the second linear direction n, to prevent the second reflection element 511 from hindering arrival of the emission light signal at the first light scanning element 31, the second reflection element 511 may be provided with a second light-passing aperture (not shown in the figure), so that the emission light signal can pass through the second light-passing aperture and then reach the first light scanning element 31.

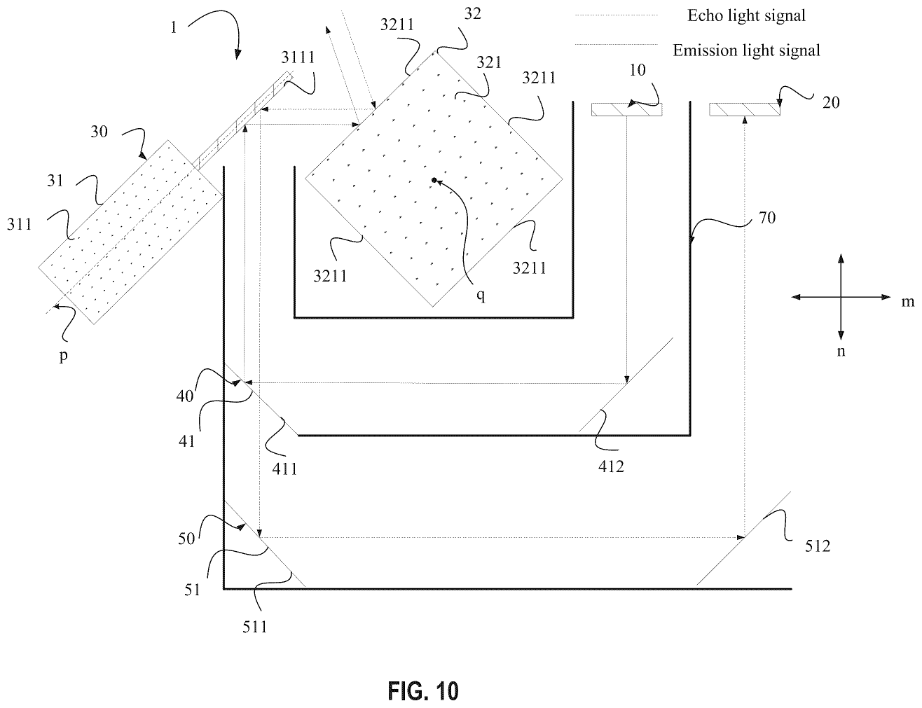

In some embodiments, referring to FIG. 10, when the first reflection element 411 is between the second reflection element 511 and the first light scanning element 31 along the second linear direction n, to prevent the first reflection element 411 from hindering transmission of the echo light signal from the first light scanning element 31 to one second reflection element 511, the first reflection element 411 may be provided with a first light-passing aperture (not shown in the figure), so that the echo light signal can pass through the first light-passing aperture and then reach the second reflection element 511.

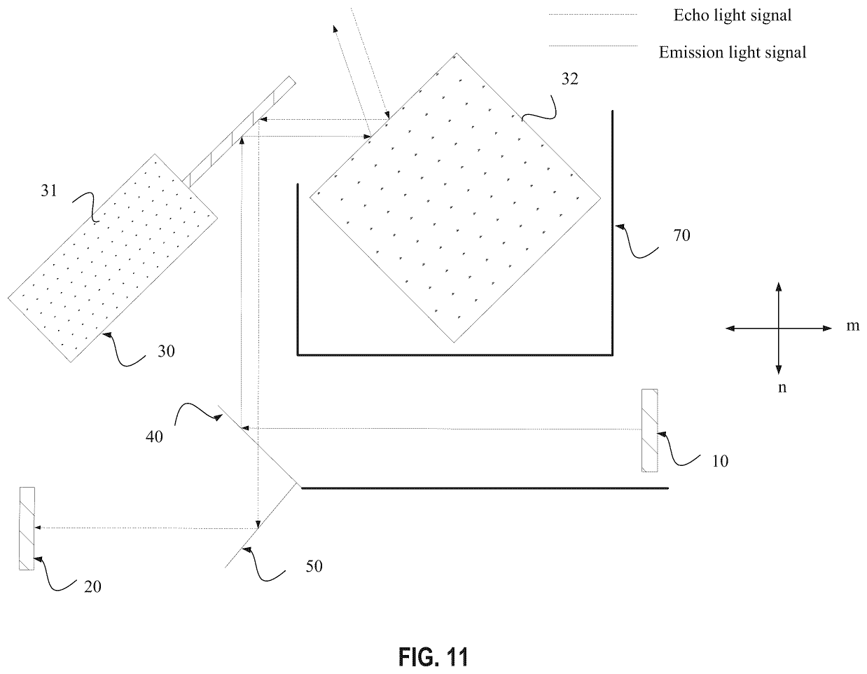

It should be noted that, in some embodiments, the second light scanning element 32 can be between the first light scanning element 31 and the light emission assembly 10 along the first linear direction m, and the second light scanning element 32 is between the first light scanning element 31 and the light receiving assembly 20 along the first linear direction m. In some embodiments, referring to FIG. 11, the second light scanning element 32 can be between the first light scanning element 31 and the light emission assembly 10 along the first linear direction m, and the second light scanning element 32 is between the light emission assembly 10 and the light receiving assembly 20 along the first linear direction m. In some embodiments, the second light scanning element 32 can be between the first light scanning element 31 and the light receiving assembly 20 along the first linear direction m, and the second light scanning element 32 is between the light emission assembly 10 and the light receiving assembly 20 along the first linear direction m. Herein, when the second light scanning element 32 is between the light emission assembly 10 and the light receiving assembly 20 along the first linear direction in, a distance between the light emission assembly 10 and the light receiving assembly 20 can be made large enough to facilitate heat dissipation.

In some embodiments, positions of the light emission assembly 10 and the light receiving assembly 20 in the drawings of this application can be switched.

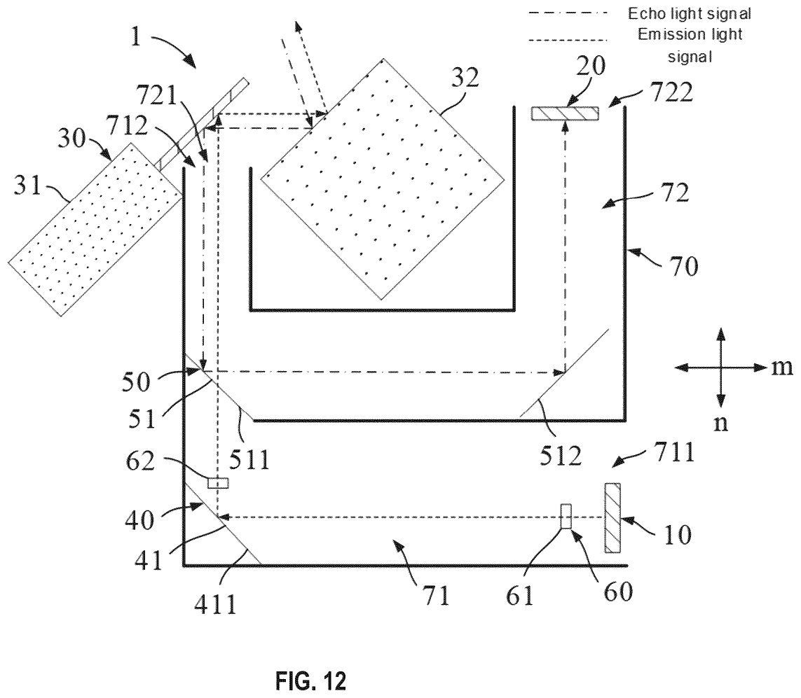

In some embodiments, referring to FIG. 12, the opto-mechanical system 1 further includes a light collimating assembly 60, and the light collimating assembly 60 is between the light emission assembly 10 and the first light scanning element 31 along the transmission path of the emission light signal. With the light collimating assembly 60 disposed, the emission light signal emitted by the opto-mechanical system 1 maintain relatively high power density when incident on a far target object. Further, in some embodiments, the light collimating assembly 60 includes a fast-axis collimating lens 61 and a slow-axis collimating lens 62. The fast-axis collimating lens 61 is between a first reflection element 41 and the light emission assembly 10, and the slow-axis collimating lens 62 is between the first reflection element 41 and the first light scanning element 31. The fast-axis collimating lens 61 and the slow-axis collimating lens 62 can collimate fast and slow axes, enhance a collimation effect, and increase output luminance of the emission light signal.

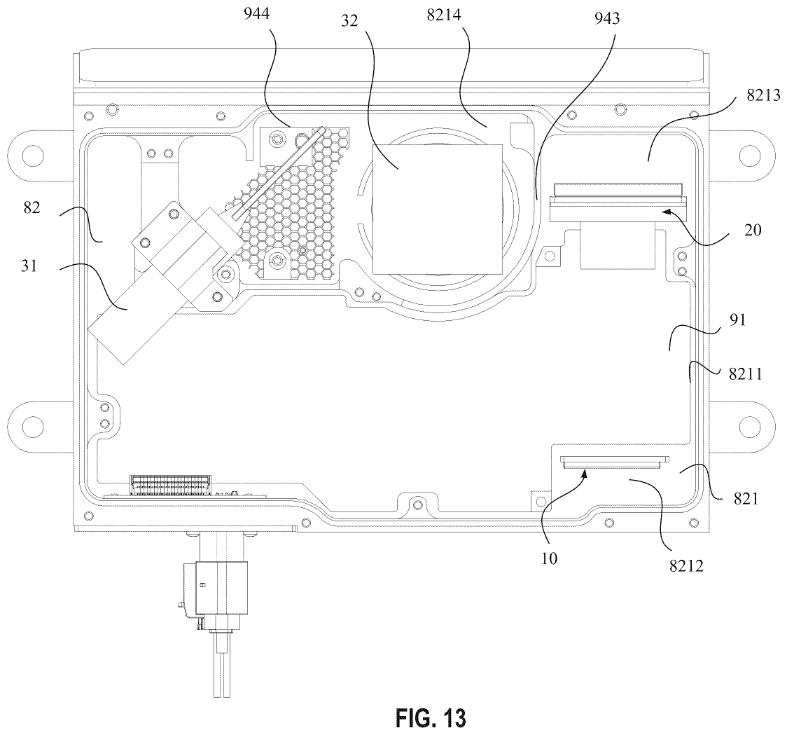

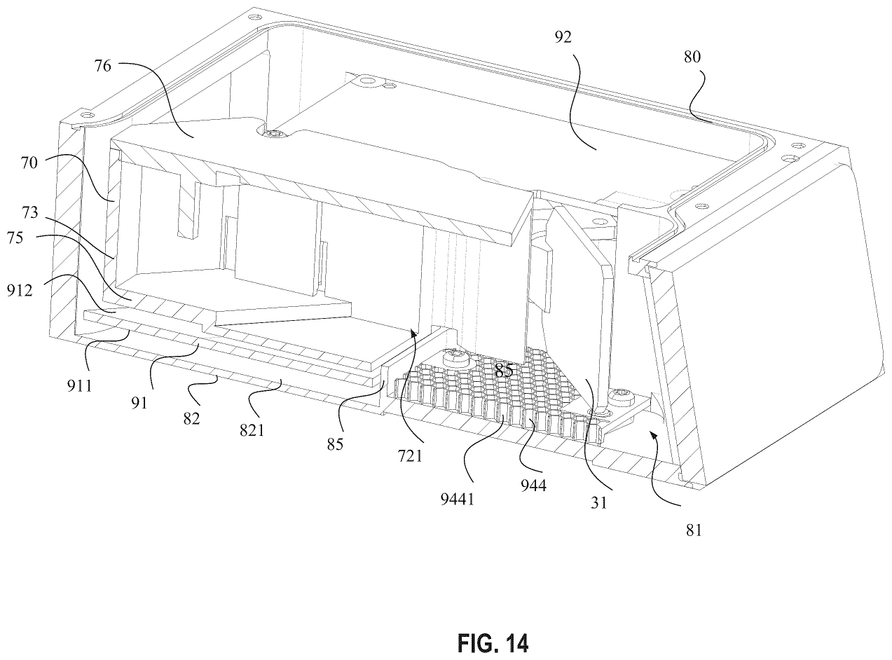

In some embodiments, referring to FIG. 13 and FIG. 14, the housing 80 includes a first board 82. The first board 82 has an inner board surface 821 forming the first accommodating cavity 81, the inner board surface 821 includes a first region 8211, and the mainboard 91 is disposed to correspond to the first region 8211. The separating member 70 is located in the first accommodating cavity 81 and is disposed on the side of the mainboard 91 that is farther away from the inner board surface 821, the separating member 70 covers at least part of the mainboard 91, and the separating member 70 and the first board 82 are both metal members. Both the separating member 70 and the first board 82 are designed to be formed by a metal member, which can form an electromagnetic shielding structure of the mainboard 91, to shield the electromagnetic radiation outside the separating member 70 and the first board 82 from affecting the mainboard 91, and to prevent the mainboard 91 from affecting outside of the separating member 70 and the first board 82 during operation. Compared with the electromagnetic shielding structure of an entire device in which the entire housing 80 is directly formed by a metal member, electromagnetic interference between the mainboard 91 and internal assemblies such as the light emission assembly 10 and the light receiving assembly 20 in the housing 80 can be avoided.

It should be noted that, not only the first board 82 is formed by a metal member, but the entire housing 80 can be formed by a metal member, to ensure the electromagnetic shielding performance of the entire device.

In some embodiments, the first cover plate 75 is disposed between the second cover plate 76 and the first board 82. For the foregoing description that “the separating member 70 is formed by a metal member”, this may mean that only the first cover plate 75 is formed by a metal member, or the entire separating member 70 is formed by a metal member. When only the first cover plate 75 is the metal member, the separating member 70 can be formed by combining the metal member and a non-metal member, to reduce overall weight and manufacturing cost of the separating member 70. For example, the separating member 70 can be formed by the metal member and the non-metal member via a dual-color injection molding process, or formed by the metal member and the non-metal member via mechanical assembly.

In some embodiments, the mainboard 91 includes a fifth board surface 911 facing the first board 82 and a sixth board surface 912 facing away from the fifth board surface 911. The first board 82 may cover the entire fifth board surface 911, and the separating member 70 may partly or completely cover the sixth board surface 912. When the separating member 70 partly covers the sixth board surface 912, the separating member 70 can cover a region of the sixth board surface 912 in which an electronic element is located, while exposing a region where electrical interfaces are located, which can not only improve the electromagnetic shielding performance of the electronic element, but also satisfy a normal electrical connection between the mainboard 91 and another assembly.

In some embodiments, referring to FIG. 2 again, the light emission assembly 10 further includes an emission shielding cover 13. The emission shielding cover 13 covers the light emitter, and the emission shielding cover 13 is provided with a second through hole 131 for an emission light signal emitted by the light emitter to pass through. The emission shielding cover 13 is disposed, so that an electromagnetic signal generated by the light emission assembly 10 and an electromagnetic signal generated by the mainboard 91 can be less prone to crosstalk. Similarly, when the light receiving assembly 20 includes a receiving shield 23, the receiving shield 23 can ensure that the electromagnetic signal generated by the light receiving assembly 20 and the electromagnetic signal generated by the mainboard 91 are less prone to crosstalk.

In some embodiments, referring to FIG. 13, the inner board surface 821 further includes a second region 8212 connected to a first region 8211, and the light emission assembly 10 is disposed to correspond to the second region 8212; and/or the inner board surface 821 further includes a third region 8213 connected to the first region 8211, and the light receiving assembly 20 is disposed to correspond to the third region 8213. The light emission assembly 10, the light receiving assembly 20, the mainboard 91 and the separating member 70 covering the mainboard 91 are distributed at different positions on the inner board surface 821, to facilitate assembly and make overall layout reasonable, thereby improving space utilization of the opto-mechanical system 1.

In some embodiments, the inner board surface 821 further includes a fourth region 8214 connected to the first region 8211, and the light scanning assembly 30 is disposed to correspond to the fourth region 8214, so that the light scanning assembly 30 and the separating member 70 covering the mainboard 91 are distributed at different positions on the inner board surface 821, to facilitate assembly.

Referring to FIG. 1 again, the opto-mechanical system 1 further includes a light blocking plate 943. The light blocking plate 943 is located in the first accommodating cavity 81 and is disposed on the side of the second light scanning element 32 that is closer to the separating member 70, an end of the light blocking plate 943 is between the second light scanning element 32 and the first light scanning element 31, and another side extends toward a direction in which the second light scanning element 32 leaves the first light scanning element 31, and is connected to the housing 80. Combining the light blocking plate 943 and the separating member 70 can further improve anti-interference performance of the emission light signal and/or the echo light signal during transmission.

In some embodiments, the opto-mechanical system 1 further includes an extinction fin 944, where the extinction fin 944 is located in the first accommodating cavity 81 and disposed to correspond to the first light outlet 712 and the second light inlet 721. The extinction fin 944 can reflect the stray light multiple times to reduce intensity of the stray light, thereby reducing the interference of the stray light to the light signal on the working band.

Further, in some embodiments, referring to FIG. 14, the extinction fin 944 is on a side of the first cover plate 75 of the separating member 70 that is farther away from the second cover plate 76 or on a side of the second cover plate 76 that is farther away from the first cover plate 75, so that the stray light is not apt to enter the second light inlet 721 after being reflected by the extinction fin 944 multiple times, and is not apt to interfere with a light signal on working band.

In some embodiments, the housing 80 includes a baffle 85, and the first cover plate 75 is between the inner board surface 821 and the second cover plate 76. The baffle 85 is between the extinction fin 944 and the separating member 70, has one end connected to the inner board surface 821 of the first board 82, and has another end extending toward the second cover plate 76, and a surface of the baffle 85 that faces away from the inner board surface 821 is on a side of the extinction fin 944 that is farther away from the inner board surface 821, to further use the baffle 85 to reduce interference of stray light to the light signal on the working band that is transmitted through the separating member 70. In some embodiments, the surface of the baffle 85 that faces away from the inner board surface 821 is on the side of the first cover plate 75 that is farther away from the inner board surface 821.

In some embodiments, the extinction fin 944 includes multiple extinction tubes 9441, an extinction aperture is disposed on the extinction tube 9441, and an extension direction of the extinction aperture is from the first cover plate 75 to the second cover plate 76, so that the stray light can be reflected multiple times in the extinction aperture. In some embodiments, the multiple extinction tubes 9441 may be roughly distributed into a honeycomb shape.

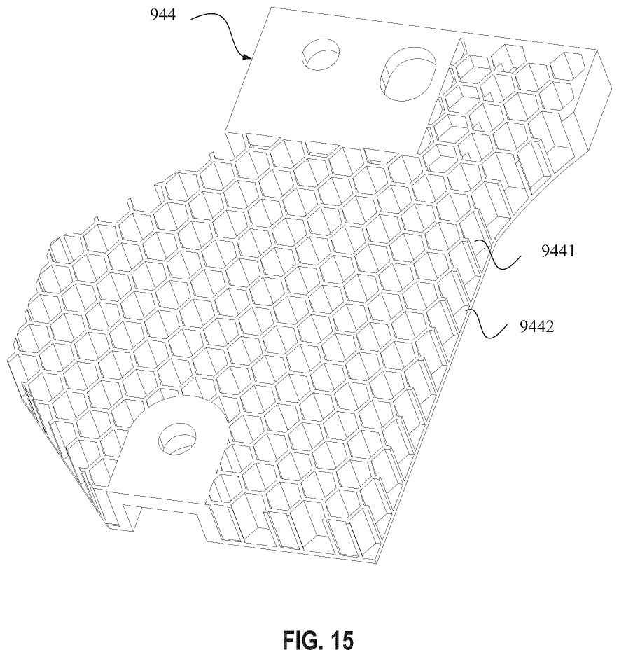

In some embodiments, referring to FIG. 15, the extinction fin 944 includes a support plate 9442. The support plate 9442 is attached to the inner board surface 821 of the first board 82 and the multiple extinction tubes 9441 are all connected to the support plate 9442, to facilitate assembly the extinction fin 944 and the housing 80.

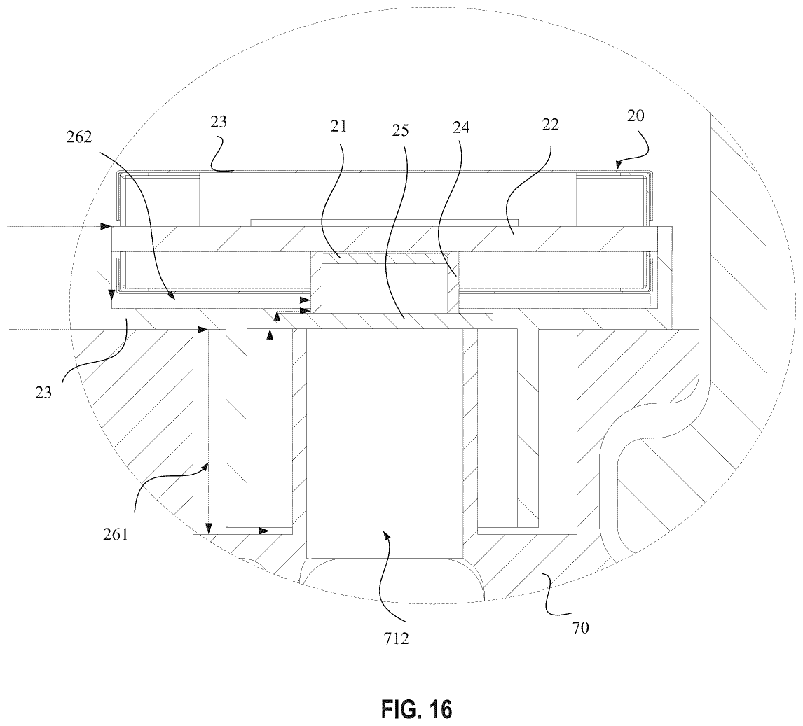

In some embodiments, referring to FIG. 16, the light receiving assembly 20 further includes a shielding ring 24 disposed on the periphery of the light receiver 21 and a light filter 25 disposed on an incident side of the light receiver 21. When a product is assembled, if there is an assembly gap, because the stray light may reach the light receiver 21 through the gap, designing the shielding ring 24 can prevent stray light at the gap from being transmitted to the light receiver 21. For example, referring to FIG. 16, the light receiving assembly 20 includes a light filter 25 disposed on the incident side of the light receiver 21. The gap between the light filter 25, the separating member 70 and the receiving shielding cover 23 may form a first stray light channel 261, and the gap between the receiving shielding cover 23 and the receiving board 22 may form the second stray light channel 262. At this time, the shielding ring 24 can be disposed on the periphery of the light receiver 21, with two ends respectively abutting a surface of the receiving board 22 that is mounted with the light receiver 21 and abutting a surface of the light filter that faces the light receiver 21 to block the first stray light channel 261 and the second stray light channel 262.

In some embodiments, the opto-mechanical system is disclosed. The opto-mechanical system includes a light emission assembly, a light receiving assembly, a mainboard, a housing, and a separating member. The mainboard is electrically connected to the light emission assembly and the light receiving assembly, and the housing includes a first board. The separating member is located in the first accommodating cavity of the housing and spaced apart from the first board, the mainboard is disposed between the first board and the separating member, and the first board and the separating member are both metal members. In the opto-mechanical system in some embodiments of this application, both the separating member and the first board are designed to be formed by a metal member, which can form an electromagnetic shielding structure of the mainboard, to shield the electromagnetic radiation outside the separating member and the first board from affecting the mainboard and to prevent the mainboard from affecting outside of the separating member and the first board during operation. In some embodiments, with the electromagnetic shielding structure formed by the separating member and the first board, electromagnetic interference between the mainboard and internal assemblies such as the light emission assembly and the light receiving assembly can be avoided, and normal operation of the mainboard is ensured.

Referring to FIG. 1 and FIG. 2, the opto-mechanical system 1 further includes a separating member 70, a housing 80, and a mainboard 91. The housing 80 forms a first accommodating cavity 81. The light emission assembly 10, the light receiving assembly 20, the separating member 70, and the mainboard 91 may all be disposed in the first accommodating cavity 81 of the housing 80. The mainboard 91 is electrically connected to the light emission assembly 10 and configured to control the light emission assembly 10 to emit an emission light signal to an irradiated object, where the mainboard 91 is electrically connected to the light receiving assembly 20 and configured to control the light receiving assembly 20 to receive the echo light signal reflected by the irradiated object.

In some embodiments, referring to FIG. 3, the housing 80 includes a first board 82. The separating member 70 is spaced apart from the first board 82, the mainboard 91 is between the separating member 70 and the first board 82, and both the separating member 70 and the first board 82 are metal members. Both the separating member 70 and the first board 82 are designed to be formed by metal members, which can form an electromagnetic shielding structure of the mainboard 91, to shield the electromagnetic radiation outside the separating member 70 and the first board 82 from affecting the mainboard 91, and to prevent the mainboard 91 from affecting outside of the separating member 70 and the first board 82 during operation. In some embodiments, with the electromagnetic shielding structure formed by the separating member 70 and the first board 82, electromagnetic interference between the mainboard 91 and internal assemblies such as the light emission assembly 10 and the light receiving assembly 20 can be avoided, and normal operation of the mainboard 91 is ensured.

It should be noted that, not only the first board 82 is formed by a metal member, but the entire housing 80 can be formed by a metal member, to ensure the electromagnetic shielding performance of the entire device.

In some embodiments, the mainboard 91 includes a fifth board surface 911 facing the first board 82 and a sixth board surface 912 facing away from the fifth board surface 911. The first board 82 may cover the entire fifth board surface 911, and the separating member 70 may partly or completely cover the sixth board surface 912. When the separating member 70 partly covers the sixth board surface 912, the separating member 70 can cover a region of the sixth board surface 912 in which an electronic element is located, while exposing a region where electrical interfaces are located, which can not only improve the electromagnetic shielding performance of the electronic element, but also satisfy a normal electrical connection between the mainboard 91 and another assembly.

In some embodiments, referring to FIG. 2 again, the light receiving assembly 20 includes a light receiver 21, a receiving board 22, and a receiving shielding cover 23. The light receiver 21 is mounted on the receiving board 22 and electrically connected to the receiving board 22, the receiving board 22 is electrically connected to the mainboard 91, the receiving shielding cover 23 covers the light receiver 21, and the receiving shielding cover 23 is provided with a first through hole 231 for the echo light signal to pass through to reach the light receiver 21. The receiving shielding cover 23 can ensure that an electromagnetic signal generated by the light receiving assembly 20 and an electromagnetic signal generated by the mainboard 91 can be mutually less prone to crosstalk. In some embodiments, the receiving board 22 and the mainboard 91 are disposed independently, which improves the heat dissipation performance of the opto-mechanical system 1 and facilitates operations such as replacement of the receiving board 22.

The light emission assembly 10 further includes a light emitter (not shown in the figure), an emission board 12, and an emission shielding cover 13. The light emitter is mounted on the emission board 12 and electrically connected to the emission board 12, the emission board 12 is electrically connected to the mainboard 91, the emission shielding cover 13 covers the light emitter, and the emission shielding cover 13 is provided with a second through hole 131 for an emission light signal emitted by the light emitter to pass through. The emission shielding cover 13 is disposed, so that an electromagnetic signal generated by the light emission assembly 10 and an electromagnetic signal generated by the mainboard 91 can be mutually less prone to crosstalk. In some embodiments, the emission board 12 and the mainboard 91 are disposed independently, which improves the heat dissipation performance of the opto-mechanical system 1 and facilitates an operation such as replacement of the emission board 12.

In some embodiments, referring to FIG. 3, the separating member 70 forms an emission light channel 71 and an echo light channel 72. The emission light channel 71 is configured to transmit the emission light signal, thereby reducing or even avoiding interference of stray light on the emission light signal. The echo light channel 72 is configured to transmit the echo light signal, thereby reducing or even avoiding interference of stray light on the echo light signal.

In some embodiments, the emission light channel 71 has a first light inlet 711 and a first light outlet 712. The light emission assembly 10 is disposed to correspond to the first light inlet 711, and the light scanning assembly 30 is disposed to correspond to the first light outlet 712, so that the emission light signal emitted by the light emission assembly 10 can enter the emission light channel 71 in a timely manner and reach the light scanning assembly 30 after being transmitted in the emission light channel 71, thereby reducing or even avoiding interference of the stray light. The echo light channel 72 has a second light inlet 721 and a second light outlet 722, the light scanning assembly 30 is disposed to correspond to the second light inlet 721, and the light receiving assembly 20 is disposed to correspond to the second light outlet 722, so that the echo light signal transmitted by the light scanning assembly 30 can enter the echo light channel 72 in a timely manner and reach the light receiving assembly 20 after being transmitted in the echo light channel 72, thereby reducing or even avoiding interference of the stray light.

In some embodiments, referring to FIG. 14 and FIG. 3, the separating member 70 includes a surrounding plate 73 and a first cover plate 75. The surrounding plate 73 is located in the first accommodating cavity 81 and is on a side of the mainboard 91 that is farther away from the first board 82, and the surrounding plate 73 forms a second accommodating cavity 731 that communicates with a first light inlet 711, a first light outlet 712, a second light inlet 721, and a second light outlet 722. The first cover plate 75 is between the surrounding plate 73 and the mainboard 91, and is connected to the surrounding plate 73, to form the second accommodating cavity 731 together with the surrounding plate 73.

In some embodiments, for the foregoing description that “the separating member 70 is formed by a metal member”, this may mean that only the first cover plate 75 is formed by a metal member, or the entire separating member 70 is formed by a metal member. When only the first cover plate 75 is the metal member, the separating member 70 can be formed by combining the metal member and a non-metal member, to reduce overall weight and manufacturing cost of the separating member 70. For example, the separating member 70 can be formed by the metal member and the non-metal member via a dual-color injection molding process, or formed by the metal member and the non-metal member via mechanical assembly.

It should be noted that at least part of the emission light channel 71 and at least part of the echo light channel 72 can be separated to improve independence of the emission light channel 71 and the echo light channel 72, and to reduce crosstalk between the emission light signal and the echo light signal.

In some embodiments, the separating member 70 further includes a partition 74. The partition 74 is located in the second accommodating cavity 731 and divides the second accommodating cavity 731 into an emission light channel 71 and an echo light channel 72. That is, at least part of the emission light channel 71 and at least part of the echo light channel 72 can be separated by the partition 74.

It should be noted that a part of the emission light channel 71 and a part of the echo light channel 72 can be separated by the partition 74, or the entire emission light channel 71 and the entire echo light channel 72 can be separated by the partition 74. This is not limited in the embodiments of this application and can be flexibly adjusted with reference to a specific requirement.

In some embodiments, when the part of the emission light channel 71 is separated from the part of the echo light channel 72, one end of the partition 74 can be connected to a part of the surrounding plate 73 that is located between the first light inlet 711 and the second light outlet 722, and another end can be located in the second accommodating cavity 731 and spaced apart from the surrounding plate 73, so that a first sub-channel 713 in the emission light channel 71 that is closer to the light emission assembly 10 is separated by the partition 74 from the second sub-channel 723 in the echo light channel 72 that is closer to the light receiving assembly 20, to prevent the emission light signal emitted by the light emission assembly 10 from interfering with the echo light signal received by the light receiving assembly 20. In addition, a third sub-channel 714 in the emission light channel 71 that is farther away from the light emission assembly 10 is communicated with a fourth sub-channel 724 in the echo light channel 72 that is farther away from the light receiving assembly 20. In this solution, the first light outlet 712 can be communicated with the second light inlet 721.

In some embodiments, when the entire emission light channel 71 is separated from the entire echo light channel 72, one end of the partition 74 can be connected to a part of the surrounding plate 73 that is located between the second light inlet 721 and the first light outlet 712, and another end can be connected to a part of the surrounding plate 73 that is located between the first light outlet 712 and the second light inlet 721, so that the entire emission light channel 71 and the entire echo light channel 72 are separated by the partition 74.

In some embodiments, the surrounding plate 73 may include a first plate 732. A first light outlet 712 and a second light inlet 721 are formed on the first plate 732. The first plate 732 is recessed toward the second accommodating cavity 731 to form avoidance space 7324, and the second light scanning element 32 is disposed in the avoidance space 7324, so that the structure of the opto-mechanical system 1 is more compact and a miniaturized design of the opto-mechanical system 1 is achieved.

In some embodiments, the surrounding plate 73 includes a second plate 733, a third plate 734, and a fourth plate 735. The second plate 733 is spaced apart from the first plate 732. The third plate 734 is connected to the first plate 732 and extends toward the second plate 733. The fourth plate 735 is connected to the second plate 733 and extends toward the first plate 732. The fourth plate 735, the first plate 732, the second plate 733, and the third plate 734 encircle and form the second accommodating cavity 731. The first light inlet 711 is disposed at a position of the second plate 733 that is closer to the third plate 734, the second light outlet 722 is disposed at a position of the first plate 732 that is closer to the third plate 734, and the partition 74 is connected to the third plate 734 and spaced apart from both the second plate 733 and the first plate 732. The surrounding plate 73 in some embodiments of this application is roughly enclosed by four plates, has a relatively simple structure and is easy to manufacture.

It should be noted that the first plate 732, the second plate 733, the third plate 734, and the fourth plate 735 may be in any shape. This is not limited in the embodiments of this application.

In some embodiments, the light emission assembly 10 is attached to and connected to a surface of the partition 74 that faces away from the first plate 732, to enhance a connection area between the light emission assembly 10 and the separating member 70 and improve connection stability of the light emission assembly 10 and the separating member 70.

In some embodiments, both the second light inlet 721 and the first light outlet 712 are located on and communicated with the first plate 732, to simplify a structural design of the separating member 70. In some embodiments, the first light outlet 712 can be located at a position of the first plate 732 that is closer to the fourth plate 735, and the first light inlet 711 is disposed at a position of the second plate 733 that is closer to the third plate 734, which can extend a distance between the first light inlet 711 and the first light outlet 712, extend a transmission path of the emission light signal, reduce a divergence angle, improve a ranging capability, and reduce light crosstalk. In some embodiments, the second light inlet 721 can be located at a position of the first plate 732 that is closer to the fourth plate 735, and the second light outlet 722 is disposed at a position of the first plate 732 that is closer to the third plate 734, which can extend a distance between the second light inlet 721 and the second light outlet 722, extend a transmission path of the echo light signal, and improve a ranging capability.

The first plate 732 has a first surface 7321 facing away from the second plate 733. The first surface 7321 includes a first sub-surface 7322 closer to the third plate 734 and a second sub-surface 7323 closer to the fourth plate 735. The second sub-surface 7323 is between the first sub-surface 7322 and the second plate 733, so that avoidance space 7324 for disposing the second light scanning element 32 is formed between the first sub-surface 7322 and the second sub-surface 7323. The first light outlet 712 and the second light inlet 721 are disposed to correspond to the second sub-surface 7323, and the second light outlet 722 is disposed to correspond to the first sub-surface 7322.

In some embodiments, referring to FIG. 5, the separating member 70 further includes a second cover plate 76. The second cover plate 76 and the first cover plate 75 may be respectively on two opposite sides of the surrounding plate 73 and both connected to the surrounding plate 73, to form the second accommodating cavity 731 together with the surrounding plate 73, so that light-shielding performance of the second accommodating cavity 731 is better and the interference of the stray light on the emission light signal and the echo light signal is reduced. In some embodiments, a connection between the first cover plate 75 and the surrounding plate 73 and a connection between the second cover plate 76 and the surrounding plate 73 can be any connection, for example, a snap-fit connection or an adhesive connection. This is not limited in the embodiments of this application. In some embodiments, the first cover plate 75 and the surrounding plate 73 can directly form an integrated structure, and the snap-fit connection of the second cover plate 76 and the surrounding plate 73 can be achieved through a structure such as a slot or a pin.

In some embodiments, the opto-mechanical system 1 further includes a light scanning assembly 30. The light scanning assembly 30 can be configured to emit, in multiple directions, the emission light signal emitted by the light emission assembly 10. The light scanning assembly 30 can be configured to transmit the echo light signal in multiple directions to the light receiving assembly 20, to improve a detection angle of view of the opto-mechanical system 1 and measure distances between the irradiated object and the opto-mechanical system 1 at different azimuths.

In some embodiments, referring to FIG. 13, the first board 82 has an inner board surface 821 forming the first accommodating cavity 81. The inner board surface 821 includes a first region 8211, and the mainboard 91 is disposed to correspond to the first region 8211. The inner board surface 821 further includes a second region 8212 connected to a first region 8211, and the light emission assembly 10 is disposed to correspond to the second region 8212. The inner board surface 821 further includes a third region 8213 connected to the first region 8211, and the light receiving assembly 20 is disposed to correspond to the third region 8213; and/or the inner board surface 821 further includes a fourth region 8214 connected to the first region 8211, and the light scanning assembly 30 is disposed to correspond to the fourth region 8214. The light emission assembly 10, the light receiving assembly 20, the light scanning assembly 30, the mainboard 91, and the separating member 70 covering the mainboard 91 are distributed at different positions on the inner board surface 821, to facilitate assembly and make overall layout reasonable, thereby improving space utilization of the opto-mechanical system 1.

In some embodiments, referring to FIG. 2 again, the opto-mechanical system 1 further includes an electronic control board 92. The electronic control board 92 is electrically connected to the mainboard 91 and the light scanning assembly 30, and is configured to control a movement of the light scanning assembly 30, to emit the emission light signal in multiple directions and/or receive the echo light signal in multiple directions. In some embodiments, the electronic control board 92 is disposed independently of the mainboard 91 and electrically connected to the mainboard 91. Compared with integrated disposition, the heat dissipation performance of the opto-mechanical system 1 can be improved, and when the product needs iteration or is inconsistent with a requirement of a customer, only the electronic control board 92 needs to be disassembled and replaced, which reduces replacement cost and improves replacement efficiency.

In some embodiments, the electronic control board 92 and the mainboard 91 can be respectively arranged on two opposite sides of the light scanning assembly 30 to increase a distance between the electronic control board 92 and the mainboard 91 and improve the heat dissipation performance of the opto-mechanical system 1.

In some embodiments, the light scanning assembly 30 may include a first light scanning element 31 and a second light scanning element 32. The emission light signal is sequentially transmitted by the first light scanning element 31 and the second light scanning element 32 to the irradiated object, and the echo light signal is sequentially transmitted by the second light scanning element 32 and the first light scanning element 31 to the light receiving assembly 20. In this case, the electronic control board 92 may be electrically connected to the first light scanning element 31 and configured to control a movement of the first light scanning element 31, and the electronic control board 92 may be electrically connected to the second light scanning element 32 and configured to control a movement of the second light scanning element 32, to combine the first light scanning element 31 and the second light scanning element 32 and emit the emission light signal in multiple directions and/or receive the echo light signal in multiple directions. In some embodiments, the electronic control board 92 may be disposed to correspond to the first light scanning element 31.

In some embodiments, both the first light scanning element 31 and the second light scanning element 32 can have a reflection structure. For example, the first light scanning element 31 can be a galvanometer or a rotating mirror, and the second light scanning element 32 can be a galvanometer or a rotating mirror. In some embodiments, the first light scanning element 31 includes a galvanometer 311, and the second light scanning element 32 includes a rotating mirror 321. In some embodiments, the galvanometer 311 has a first reflection surface 3111 for transmitting an emission light signal and/or an echo light signal, the electronic control board 92 may be electrically connected to the galvanometer 311 and configured to control the galvanometer 311 to rotate around the first rotation axis p, and the first reflection surface 3111 faces the second light scanning element 32. The rotating mirror 321 has multiple second reflection surfaces 3211 for transmitting the emission light signal and/or the echo light signal, the electronic control board 92 may be electrically connected to the rotating mirror 321 and configured to control the rotating mirror 321 to rotate around the second rotation axis q, and the multiple second reflection surfaces 3211 are arranged around a periphery of the second rotation axis q, so that at least one second reflection surface 3211 faces the first reflection surface 3111 of the first light scanning element 31 when the rotating mirror 321 rotates around the second rotation axis q.

In some embodiments, the reflection surface (for example, the first reflection surface 3111 and the second reflection surface 3211) can reflect the light signal (for example, the emission light signal and the echo light signal), and change the transmission direction of the light signal, so that the light signal can be smoothly transmitted backward.

In some embodiments, the first rotation axis p may be perpendicular to the second rotation axis q. Herein, rotation of the galvanometer 311 around the first rotation axis p can implement adjustment of an angle of view in a direction, and rotation of the rotating mirror 321 around the second rotation axis q can implement adjustment of the angle of view in another direction. In addition, when the first rotation axis p is perpendicular to the second rotation axis q, adjustment directions of the two angles of view may be perpendicular to each other. For example, the rotation of the galvanometer 311 around the first rotation axis p can implement adjustment in a vertical angle of view, and the rotation of the rotating mirror 321 around the second rotation axis q can implement adjustment in a horizontal angle of view. In some embodiments of this application, the rotating mirror 321 can implement scanning at a horizontal angle of view of 120°, and the galvanometer 311 can implement scanning at a vertical angle of view of 25°, to complete scanning of space at a full angle of view of 120°×25°.

In some embodiments, the opto-mechanical system 1 further includes an interface board 93, the interface board 93 is disposed independently of the mainboard 91 and electrically connected to the mainboard 91. The interface board 93 is configured to provide a power supply signal for at least one of the light emission assembly 10, the light receiving assembly 20, and the light scanning assembly 30. Because this may be inconsistent with an interface requirement of a user, the interface board 93 is disposed independently of the mainboard 91, which can facilitate replacement or repair of the interface board 93 and further improve the heat dissipation performance of the opto-mechanical system 1.

In some embodiments, the mainboard 91, the electronic control board 92, the emission board 12, the receiving board 22, and the interface board 93 are disposed independently of each other, so that only a part of a board needs to be updated and redesigned when the product needs iteration or is inconsistent with a requirement of the user, thereby saving cost and time and achieving better heat dissipation effect.

In some embodiments, the housing 80 may include a box 83 and a cover 84 connected to the box 83. The box 83 and the cover 84 jointly define a first accommodating cavity 81, the electronic control board 92 can be disposed close to the cover 84, and the mainboard 91 can be disposed close to a bottom of the box 83. Further, a visible window corresponding to the electronic control board 92 may be disposed on the cover 84, so that staff can check an operation status of the electronic control board 92 and find a fault in a timely manner when the fault occurs.

To facilitate heat dissipation of components such as the light emission assembly 10, the light receiving assembly 20, the mainboard 91, the electronic control board 92, and the interface board 93 in the first accommodating cavity 81 during use and ensure the normal operation of the opto-mechanical system 1. In some embodiments, a first heat conduction member 941 may be disposed between the emission board 12 of the light emission assembly 10 and the housing 80; a second heat conduction member 942 may be disposed between the receiving board 22 of the light receiving assembly 20 and the housing 80; a fourth heat conduction member (not shown in the figure) may be disposed between the mainboard 91 and the housing 80; a fifth heat conduction member (not shown in the figure) may be disposed between the electronic control board 92 and the housing 80; and/or a sixth heat conduction member (not shown in the figure) may be disposed between the interface board 93 and the housing 80. Therefore, heat generated by the light emission assembly 10, the light receiving assembly 20, the mainboard 91, the electronic control board 92, and the interface board 93 during use can be transferred to the housing 80 through corresponding heat conduction members and further dissipated outside.

It should be noted that the emission board 12 of the light emission assembly 10, the receiving board 22 of the light receiving assembly 20, the mainboard 91, the electronic control board 92, and the interface board 93 can be directly connected to the housing 80 through the corresponding heat conduction members, or can be connected to the housing 80 through middleware, which is not limited in this application. In some embodiments of this application, the mainboard 91, the electronic control board 92, and the interface board 93 are directly connected to the housing 80 through the corresponding heat conduction members, and the emission board 12 and the receiving board 22 are connected to the housing 80 through middleware. More detailed description is provided below.

In some embodiments, both the light emission assembly 10 and the light receiving assembly 20 can be connected to the separating member 70, a third heat conduction member (not shown in the figure) can be provided between the separating member 70 and the housing 80, and the emission board 12 and the receiving board 22 can be connected to the housing 80 through the separating member 70, so that heat generated by the emission board 12 and the receiving board 22 can be transferred to the separating member 70, then transferred to the housing 80 via the separating member 70, and then dissipated outside.

In some embodiments, the emission board 12 has a first board surface 121 and a second board surface 122 facing away from the first board surface 121. The first board surface 121 is mounted with the light emitter, and the first heat conduction member 941 is disposed between the second board surface 122 and the separating member 70, so that heat generated by the emission board 12 can be transferred to the separating member 70 through the first heat conduction member 941, then transferred to the housing 80 through the separating member 70, and then dissipated outside. In some embodiments, the first heat conduction member 941 may include a graphene layer and a heat conduction gel layer. In some embodiments, the emission board 12 includes a substrate and a conductive layer disposed on the substrate, and the substrate can be a plate with better heat dissipation performance. For example, the substrate can be a ceramic plate.

In some embodiments, referring to FIG. 2 and FIG. 4, the receiving board 22 has a third board surface 221 and a fourth board surface 222 facing away from the third board surface 221, and the third board surface 221 is mounted with the light receiver 21. A first heat conduction sub-member 9421 is disposed between the third board surface 221 and the receiving shielding cover 23, a second heat conduction sub-member 9422 is disposed between the fourth board surface 222 and the receiving shielding cover 23, a third heat conduction sub-member 9423 is disposed between the receiving shielding cover 23 and the separating member 70, and the second heat conduction member 942 includes the first heat conduction sub-member 9421, the second heat conduction sub-member 9422, and the third heat conduction sub-member 9423, so that heat generated by the receiving board 22 can be transferred to the receiving shielding cover 23 and the separating member 70, and heat on the separating member 70 can be further transferred to the housing 80, and then dissipated outside. In some embodiments, both the first heat conduction sub-member 9421 and the second heat conduction sub-member 9422 may include a heat conduction gel layer, and the third heat conduction sub-member 9423 includes the graphene layer and the heat conduction gel layer.

In some embodiments, the receiving shielding cover 23 may include a first shielding sub-cover 232 on a side on which the third board surface 221 is located and a second shielding sub-cover 233 on a side on which the fourth board surface 222 is located, and both the first shielding sub-cover 232 and the second shielding sub-cover 233 are connected to the receiving board 22.

In some embodiments, each of the third heat conduction member, the fourth heat conduction member, the fifth heat conduction member, and the sixth heat conduction member may include the heat conduction gel layer.

Referring to FIG. 1 again, the opto-mechanical system 1 further includes a light blocking plate 943. The light blocking plate 943 is located in the first accommodating cavity 81 and is disposed on the side of the second light scanning element 32 that is closer to the separating member 70. An end of the light blocking plate 943 is between the second light scanning element 32 and the first light scanning element 31, and another side extends toward a direction in which the second light scanning element 32 leaves the first light scanning element 31, and is connected to the housing 80. Combining the light blocking plate 943 and the separating member 70 can further improve anti-interference performance of the emission light signal and/or the echo light signal during transmission.

In some embodiments, the opto-mechanical system 1 further includes an extinction fin 944, where the extinction fin 944 is located in the first accommodating cavity 81 and disposed to correspond to the first light outlet 712 and the second light inlet 721. The extinction fin 944 can reflect the stray light multiple times to reduce intensity of the stray light, thereby reducing the interference of the stray light to the light signal on the working band.

Further, in some embodiments, referring to FIG. 14, the extinction fin 944 is on a side of the first cover plate 75 of the separating member 70 that is farther away from the second cover plate 76, or on a side of the second cover plate 76 that is farther away from the first cover plate 75, so that the stray light is not apt to enter the second light inlet 721 after being reflected by the extinction fin 944 multiple times, and is not apt to interfere with a light signal on working band.

In some embodiments, the housing 80 includes a baffle 85, and the first cover plate 75 is between the inner board surface 821 and the second cover plate 76. The baffle 85 is between the extinction fin 944 and the separating member 70, has one end connected to the inner board surface 821 of the first board 82, and has another end extending toward the second cover plate 76. A surface of the baffle 85 that faces away from the inner board surface 821 is on a side of the extinction fin 944 that is farther away from the inner board surface 821, to further use the baffle 85 to reduce interference of stray light to the light signal on the working band that is transmitted through the separating member 70. In some embodiments, the surface of the baffle 85 that faces away from the inner board surface 821 is on the side of the first cover plate 75 that is farther away from the inner board surface 821.

In some embodiments, the extinction fin 944 includes multiple extinction tubes 9441. An extinction aperture is disposed on the extinction tube 9441, and an extension direction of the extinction aperture is from the first cover plate 75 to the second cover plate 76, so that the stray light can be reflected multiple times in the extinction aperture. In some embodiments, the multiple extinction tubes 9441 may be roughly distributed into a honeycomb shape.

In some embodiments, referring to FIG. 15, the extinction fin 944 includes a support plate 9442. The support plate 9442 is attached to the inner board surface 821 of the first board 82, and the multiple extinction tubes 9441 are all connected to the support plate 9442, to facilitate assembly the extinction fin 944 and the housing 80.

In some embodiments, referring to FIG. 16, the light receiving assembly 20 further includes a shielding ring 24 disposed on the periphery of the light receiver 21 and a light filter 25 disposed on an incident side of the light receiver 21. When a product is assembled, if there is an assembly gap, because the stray light may reach the light receiver 21 through the gap, designing the shielding ring 24 can prevent stray light at the gap from being transmitted to the light receiver 21. For example, referring to FIG. 16, the light receiving assembly 20 includes a light filter 25 disposed on the incident side of the light receiver 21. The gap between the light filter 25, the separating member 70, and the receiving shielding cover 23 may form a first stray light channel 261. The gap between the receiving shielding cover 23 and the receiving board 22 may form the second stray light channel 262. At this time, the shielding ring 24 can be disposed on the periphery of the light receiver 21, with two ends respectively abutting a surface of the receiving board 22 that is mounted with the light receiver 21 and abutting a surface of the light filter that faces the light receiver 21 to block the first stray light channel 261 and the second stray light channel 262.

In some embodiments, referring to FIG. 6 and FIG. 7, along the first linear direction m, the second light scanning element 32 is between the first light scanning element 31 and the light emission assembly 10. The emission light signal is emitted through the second light scanning element 32. The second light scanning element 32 is between the first light scanning element 31 and the light emission assembly 10, and an outgoing position of the emission light signal can be roughly in the middle of the opto-mechanical system 1, which facilitates calibration of the opto-mechanical system 1 and symmetry of a short-distance point cloud.

In some embodiments, along the first linear direction m, the second light scanning element 32 is between the first light scanning element 31 and the light emission assembly 10. Therefore, a transmission path of the emission light signal sent by the light emission assembly 10 from the light emission assembly 10 to the first light scanning element 31 can be extended, which facilitates a reduction in a divergence angle and improves ranging capability of the opto-mechanical system 1. In some embodiments, the opto-mechanical system 1 satisfies the following conditional formula 1: SNR∝Pₜ\sqrt{A_{rec}/A_{FOV}}, where SNR is a signal-to-noise ratio of the echo light signal, Pt is total emission power, Arec is a receiving cross section, and AFOV is a receiving angle of view. It can be learned from the foregoing conditional formula 1 that a value of the receiving angle of view AFOV determines magnitude of noise in the echo light signal. The larger the receiving angle of view AFOV, the greater the received noise. Therefore, it is necessary to reduce the receiving angle of view AFOV. In addition, the receiving angle of view AFOV is related to the size of a light receiver 21 in the light receiving assembly 20 and focal length of a receiving lens. For example, if the divergence angle δθ is 0.2°×0.2°, the size of the light receiver 21 or the focal length of the receiving lens can be customized, so that the receiving angle of view AFOV is slightly greater than 0.2°×0.2°, thereby ensuring that all the echo light signals can be received by the light receiver 21 and avoiding loss of a light signal. In the following conditional formula 2 of the opto-mechanical system 1: δθ=L/f, where δθ is a divergence angle of the emission light signal, L is a light emission area of the light emission assembly 10, and f is focal length of an emission lens in the light emission assembly 10. It can be learned from the foregoing conditional formula 2 that a telephoto system can reduce the divergence angle 80. With the reduction in the divergence angle 80, the receiving angle of view AFOV can be made smaller, noise is reduced, and the detection capability of the opto-mechanical system 1 is improved. In addition, the transmission path of the emission light signal is extended, and crosstalk between channels can be further reduced.

It should be noted that along the first linear direction m, the second light scanning element 32 is between the first light scanning element 31 and the light emission assembly 10. The emission light signal sent by the light emission assembly 10 passes through the first light scanning element 31 and the second light scanning element 32 in sequence. The emission light signal emitted by the light emission assembly 10 may be interfered with by the second light scanning element 32 when reaching the first light scanning element 31. In this regard, the opto-mechanical system 1 in some embodiments of this application may include a first light path changing assembly 40, and along the transmission path of the emission light signal, the first light path changing assembly 40 is disposed between the light emission assembly 10 and the first light scanning element 31. With the first light path changing assembly 40 disposed, the transmission path of the emission light signal emitted by the light emission assembly 10 changes from a transmission path of the first light scanning element 31 and the second light scanning element 32 in sequence to a transmission path of the first light path changing assembly 40, the first light scanning element 31, and the second light scanning element 32 in sequence, which can avoid interference from the second light scanning element 32 when the emission light signal is transmitted from the light emission assembly 10 to the first light path changing assembly 40 and when the emission light signal is transmitted from the first light path changing assembly 40 to the first light scanning element 31, thereby ensuring normal transmission of the emission light signal.

In some embodiments, the first light path changing assembly 40 includes at least one first reflection element 41, and the transmission path of the emission light signal can be deflected by the reflection surface of the first reflection element 41, to ensure that the emission light signal can be smoothly transmitted to the first light scanning element 31.

It should be noted that, in foregoing case that along the first linear direction m, the second light scanning element 32 is between the first light scanning element 31 and the light emission assembly 10. This may mean that the second light scanning element 32, the first light scanning element 31, and the light emission assembly 10 are roughly in the same line, and the second light scanning element 32 is between the first light scanning element 31 and the light emission assembly 10. Or this may mean that projection of the second light scanning element 32, the first light scanning element 31, and the light emission assembly 10 on the same line satisfies that the second light scanning element 32 is between the first light scanning element 31 and the light emission assembly 10, to reduce an assembly accuracy requirement of the second light scanning element 32, the first light scanning element 31, and the light emission assembly 10, and to reduce assembly difficulty.

In some embodiments, for a case that the light emission assembly 10 may be on a side of the second light scanning element 32 that faces away from the irradiated object along the second linear direction n, refer to FIG. 6. For a case that the light emission assembly 10 may be on a side of the second light scanning element 32 that is closer to the irradiated object, refer to FIG. 7. The second linear direction n intersects with the first linear direction m. Referring to FIG. 6, when the light emission assembly 10 is on a side of the second light scanning element 32 that is farther away from the irradiated object along the second linear direction n, in some embodiments, in all first reflection elements 41 of the first light path changing assembly 40, one first reflection element 411 may be distributed along the second linear direction n together with the first light scanning element 31 and may be on a side of the first light scanning element 31 that is farther away from the irradiated object. In some embodiments of this application, one first reflection element is numbered with 411, to distinguish the number 41 of another first reflection element when the first light path changing assembly 40 includes multiple first reflection elements. It should be noted that, at this time, the first light path changing assembly 40 may include only one first reflection element 41.

Referring to FIG. 7, when the light emission assembly 10 is on a side of the second light scanning element 32 that is closer to the irradiated object along the second linear direction n, in some embodiments, in all the first reflection elements 41, one first reflection element 411 may be distributed along the second linear direction n together with the first light scanning element 31 and may be on a side of the first light scanning element 31 that is farther away from the irradiated object. Another first reflection element 412 may be distributed along the second linear direction n together with the second light scanning element 32 and may be on a side of the second light scanning element 32 that is farther away from the irradiated object. Along the transmission path of the emission light signal, a still another first reflection element 412 is between the light emission assembly 10 and the first reflection element 411. In some embodiments of this application, one first reflection element is numbered with 411, and another first reflection element is numbered with 412 for distinction.

It should be noted that the first reflection element 41 may be replaced with a refraction element or the like, and a specific structural design of the first light path changing assembly 40 is not limited in the embodiments of this application.

In some embodiments, along the first linear direction m, the second light scanning element 32 is between the first light scanning element 31 and the light receiving assembly 20. The echo light signal is emitted to the opto-mechanical system 1 through the second light scanning element 32, the second light scanning element 32 is between the first light scanning element 31 and the light receiving assembly 20, and an incident position of the echo light signal can be roughly in the middle of the opto-mechanical system 1, which facilitates calibration of the opto-mechanical system 1 and symmetry of a short-distance point cloud.

In some embodiments, along the first linear direction in, the second light scanning element 32 is between the first light scanning element 31 and the light receiving assembly 20. Therefore, a transmission path of the echo light signal from the first light scanning element 31 to the light receiving assembly 20 can be extended, which facilitates a reduction in noise received by the light receiver 21 and improves the ranging capability of the opto-mechanical system 1. In some embodiments, due to processing tolerance or cost, a photosensitive surface of the light receiver 21 is usually about 0.5 mm. For a system with a small divergence angle, a design of short focal length makes a receiving angle of view corresponding to the 0.5 mm photosensitive surface relatively redundant, which increases received noise. However, the focal length of the opto-mechanical system 1 in this application can be 50 mm, to reduce the receiving angle of view. Disposing the second light path changing assembly 50 and/or the first light path changing assembly 40 can improve a space utilization rate of an entire device and make a structure thereof more compact.

When the opto-mechanical system 1 is applied to autonomous driving, a detection capability of 250 m@10% and a resolution capability of less than 0.1° can be achieved, thereby meeting the requirement of high-precision imaging.

It should be noted that along the first linear direction m, the second light scanning element 32 is between the first light scanning element 31 and the light receiving assembly 20. The echo light signal passes through the second light scanning element 32 and the first light scanning element 31 in sequence to reach the light receiving assembly 20, and the echo light signal may be interfered with the second light scanning element 32 when being transmitted from the first light scanning element 31 to the light receiving assembly 20. In this regard, the opto-mechanical system 1 in some embodiments of this application may include a second light path changing assembly 50. Along the transmission path of the echo light signal, the second light path changing assembly 50 is disposed between the light receiving assembly 20 and the first light scanning element 31. With the second light path changing assembly 50 disposed, the transmission path of the echo light signal changes from a transmission path of passing through the first light scanning element 31 and then reaching the light receiving assembly 20 to a transmission path of passing through the first light scanning element 31 and the second light path changing assembly 50 and then reaching the light receiving assembly 20, which can avoid interference from the second light scanning element 32 when the echo light signal is transmitted from the first light scanning element 31 to the second light path changing assembly 50 and when the echo light signal is transmitted from the second light path changing assembly 50 to the light receiving assembly 20, thereby ensuring normal transmission of the echo light signal.

In some embodiments, the second light path changing assembly 50 includes at least one second reflection element 51, and the transmission path of the echo light signal can be deflected by a reflection surface of the second reflection element 51, to ensure that the echo light signal can be smoothly transmitted to the light receiving assembly 20.

It should be noted that, in foregoing case that along the first linear direction m, the second light scanning element 32 is between the first light scanning element 31 and the light receiving assembly 20. This may mean that the second light scanning element 32, the first light scanning element 31, and the light receiving assembly 20 are roughly in the same line, and the second light scanning element 32 is between the first light scanning element 31 and the light receiving assembly 20. Or this may mean that projection of the second light scanning element 32, the first light scanning element 31, and the light receiving assembly 20 on the same line satisfies that the second light scanning element 32 is between the first light scanning element 31 and the light receiving assembly 20, to reduce an assembly accuracy requirement of the second light scanning element 32, the first light scanning element 31, and the light receiving assembly 20, and to reduce assembly difficulty.

In some embodiments, for a case that the light receiving assembly 20 may be on a side of the second light scanning element 32 that is closer to the irradiated object along the second linear direction n, refer to FIG. 6 and FIG. 7. For a case that the light receiving assembly 20 may be on a side of the second light scanning element 32 that is farther away from the irradiated object, refer to FIG. 8 and FIG. 9. Referring to FIG. 6 and FIG. 7, when the light receiving assembly 20 is on a side of the second light scanning element 32 that is closer to the irradiated object along the second linear direction n, in some embodiments, in all the second reflection elements 51 included in the second light path changing assembly 50, one second reflection element 511 may be distributed along the second linear direction n together with the first light scanning element 31 and may be on a side of the first light scanning element 31 that is farther away from the irradiated object. Another second reflection element 512 may be distributed along the second linear direction n together with the second light scanning element 32 and may be on a side of the second light scanning element 32 that is farther away from the irradiated object. And along the transmission path of the echo light signal, a still another second reflection element 512 is between the second reflection element 511 and the light receiving assembly 20. In some embodiments of this application, one second reflection element is numbered with 511, and another second reflection element is numbered with 512 for distinction.

Referring to FIG. 8 and FIG. 9, when the light receiving assembly 20 is on a side of the second light scanning element 32 that is farther away from the irradiated object along the second linear direction n, in some embodiments, in all second reflection elements 51, one second reflection element 511 may be distributed along the second linear direction n together with the first light scanning element 31 and may be on a side of the first light scanning element 31 that is farther away from the irradiated object. In some embodiments of this application, one second reflection element is numbered with 511, to distinguish the number 51 of another second reflection element when the second light path changing assembly 50 includes multiple second reflection elements. It should be noted that, at this time, the second light path changing assembly 50 may include only one second reflection element 51.

In some embodiments, when the second reflection element 511 is between the first reflection element 411 and the first light scanning element 31 along the second linear direction n, to prevent the second reflection element 511 from hindering arrival of the emission light signal at the first light scanning element 31, the second reflection element 511 may be provided with a second light-passing aperture (not shown in the figure), so that the emission light signal can pass through the second light-passing aperture and then reach the first light scanning element 31.

In some embodiments, referring to FIG. 10, when the first reflection element 411 is between the second reflection element 511 and the first light scanning element 31 along the second linear direction n, to prevent the first reflection element 411 from hindering transmission of the echo light signal from the first light scanning element 31 to one second reflection element 511, the first reflection element 411 may be provided with a first light-passing aperture (not shown in the figure), so that the echo light signal can pass through the first light-passing aperture and then reach the second reflection element 511.

It should be noted that, in some embodiments, the second light scanning element 32 can be between the first light scanning element 31 and the light emission assembly 10 along the first linear direction m, and the second light scanning element 32 is between the first light scanning element 31 and the light receiving assembly 20 along the first linear direction m. In some embodiments, referring to FIG. 11, the second light scanning element 32 can be between the first light scanning element 31 and the light emission assembly 10 along the first linear direction in, and the second light scanning element 32 is between the light emission assembly 10 and the light receiving assembly 20 along the first linear direction m. In some embodiments, the second light scanning element 32 can be between the first light scanning element 31 and the light receiving assembly 20 along the first linear direction in, and the second light scanning element 32 is between the light emission assembly 10 and the light receiving assembly 20 along the first linear direction m. Herein, when the second light scanning element 32 is between the light emission assembly 10 and the light receiving assembly 20 along the first linear direction m, a distance between the light emission assembly 10 and the light receiving assembly 20 can be made large enough to facilitate heat dissipation.

In some embodiments, positions of the light emission assembly 10 and the light receiving assembly 20 in the drawings can be switched.

In some embodiments, referring to FIG. 12, the opto-mechanical system 1 further includes a light collimating assembly 60, and the light collimating assembly 60 is between the light emission assembly 10 and the first light scanning element 31 along the transmission path of the emission light signal. With the light collimating assembly 60 disposed, the emission light signal emitted by the opto-mechanical system 1 maintain relatively high power density when incident on a far irradiated object. Further, in some embodiments, the light collimating assembly 60 includes a fast-axis collimating lens 61 and a slow-axis collimating lens 62, the fast-axis collimating lens 61 is between a first reflection element 41 and the light emission assembly 10, and the slow-axis collimating lens 62 is between the first reflection element 41 and the first light scanning element 31. The fast-axis collimating lens 61 and the slow-axis collimating lens 62 can collimate fast and slow axes, enhance a collimation effect, and increase output luminance of the emission light signal.

In some embodiments, the light scanning assembly comprises: a first light scanning element including a galvanometer, where the galvanometer has a first reflection surface for transmitting the emission light signal and/or the echo light signal, and the galvanometer can rotate around a first rotation axis; and a second light scanning element including a rotating mirror, where the rotating mirror has multiple second reflection surfaces for transmitting the emission light signal and/or the echo light signal, the rotating mirror can rotate around a second rotation axis, and the multiple second reflection surfaces are disposed around a periphery of the second rotation axis, so that at least one second reflection surface faces the first reflection surface, where the emission light signal emitted by the light emission assembly is sequentially transmitted by the first light scanning element and the second light scanning element to the irradiated object, and the light receiving assembly sequentially receives the echo light signal of the irradiated object that is transmitted by the second light scanning element and the first light scanning element.

In some embodiments, the first board has an inner board surface forming the first accommodating cavity. The inner board surface includes a first region, and the mainboard is disposed to correspond to the first region. The inner board surface further includes a second region connected to a first region, and the light emission assembly is disposed to correspond to the second region. The inner board surface further includes a third region connected to the first region, and the light receiving assembly is disposed to correspond to the third region. The inner board surface further includes a fourth region connected to the first region, and the light scanning assembly is disposed to correspond to the fourth region.

In the description of the present application, it shall be understood that the terms such as “first” and “second” are merely intended for a purpose of description, and shall not be understood as an indication or implication of relative importance. In addition, in the descriptions of this application, “a plurality of” means two or more unless otherwise specified. Herein, “and/or” is an association relationship for describing associated objects and indicates that three relationships may exist. For example, A and/or B may mean the following three cases: Only A exists, both A and B exist, and only B exists. The character “/” generally indicates an “or” relationship between the associated objects.

The disclosed forgoing are only preferred embodiments of the present application, which of course cannot be used to limit the scope of rights of the present application. Therefore, equivalent changes made in accordance with the claims of the present application still fall within the scope of the application.

What is claimed is:

1. An opto-mechanical system, comprising:
a light emission assembly;
a light receiving assembly;
a mainboard, wherein the mainboard is electrically connected to the light emission assembly and configured to control the light emission assembly to emit an emission light signal to a target object, and is electrically connected to the light receiving assembly and configured to control the light receiving assembly to receive an echo light signal reflected by the target object;
a light scanning assembly, wherein the emission light signal is transmitted by the light scanning assembly to the target object, and the echo light signal is transmitted by the light scanning assembly to the light receiving assembly; and
an electronic control board, disposed independently of the mainboard and electrically connected to the mainboard, wherein the electronic control board is electrically connected to the light scanning assembly to control a movement of the light scanning assembly.

2. The opto-mechanical system according to claim 1, wherein the electronic control board and the mainboard are respectively disposed on two opposite sides of the light scanning assembly.

3. The opto-mechanical system according to claim 1, wherein the light scanning assembly comprises:
a first light scanning element, wherein the electronic control board is electrically connected to the first light scanning element and configured to control a movement of the first light scanning element; and
a second light scanning element, wherein the emission light signal is sequentially transmitted by the first light scanning element and the second light scanning element to the target object, the echo light signal is sequentially transmitted by the second light scanning element and the first light scanning element to the light receiving assembly, and the electronic control board is further electrically connected to the second light scanning element and is configured to control a movement of the second light scanning element.

4. The opto-mechanical system according to claim 3, wherein the first light scanning element comprises a galvanometer, the galvanometer has a first reflection surface for transmitting the emission light signal or the echo light signal, the electronic control board is electrically connected to the galvanometer and configured to control the galvanometer to rotate around a first rotation axis, and the first reflection surface faces the second light scanning element; or
the second light scanning element comprises a rotating mirror, the rotating mirror has multiple second reflection surfaces for transmitting the emission light signal or the echo light signal, the electronic control board is electrically connected to the rotating mirror and configured to control the rotating mirror to rotate around a second rotation axis, and the multiple second reflection surfaces are disposed around a periphery of the second rotation axis, so that at least one second reflection surface faces the first light scanning element when the rotating mirror rotates around the second rotation axis.

5. The opto-mechanical system according to claim 1, wherein the light emission assembly comprises a light emitter and an emission board, the light emitter is mounted on the emission board and electrically connected to the emission board, and the emission board is disposed independently of the mainboard and electrically connected to the mainboard; and
the light receiving assembly comprises a light receiver and a receiving board, the light receiver is mounted on the receiving board and electrically connected to the receiving board, and the receiving board is disposed independently of the mainboard and electrically connected to the mainboard.

6. The opto-mechanical system according to claim 5, wherein the opto-mechanical system further comprises:
a housing having a first accommodating cavity, wherein the light emission assembly, the light receiving assembly, the mainboard, the light scanning assembly, and the electronic control board are located in the first accommodating cavity; and
a first heat conduction member disposed between the emission board and the housing, and a second heat conduction member disposed between the receiving board and the housing.

7. The opto-mechanical system according to claim 6, further comprising:
a separating member, located in the first accommodating cavity and forming an emission light channel and an echo light channel, wherein the emission light channel has a first light inlet and a first light outlet, the echo light channel has a second light inlet and a second light outlet, the light emission assembly is disposed to correspond to the first light inlet, the light scanning assembly is disposed to correspond to the first light outlet, the light scanning assembly is disposed to correspond to the second light inlet, the light receiving assembly is disposed to correspond to the second light outlet, and a third heat conduction member is disposed between the separating member and the housing.

8. The opto-mechanical system according to claim 7, wherein
the emission board has a first board surface and a second board surface facing away from the first board surface, the first board surface is mounted with the light emitter, and the first heat conduction member is disposed between the second board surface and the separating member; or
the first heat conduction member comprises a graphene layer and a heat conduction gel layer; or
the light receiving assembly comprises a receiving shielding cover covering the receiving board and the light receiver, the receiving shielding cover is provided with a first through hole corresponding to the light receiver, the receiving board has a third board surface and a fourth board surface facing away from the third board surface, the third board surface is mounted with the light receiver, a first heat conduction sub-member is disposed between the third board surface and the receiving shielding cover, a second heat conduction sub-member is disposed between the fourth board surface and the receiving shielding cover, a third heat conduction sub-member is disposed between the receiving shielding cover and the separating member, and the second heat conduction member comprises the first heat conduction sub-member, the second heat conduction sub-member, and the third heat conduction sub-member; or
the emission board comprises a substrate and a conductive layer disposed on the substrate, and the substrate comprises a ceramic plate.

9. The opto-mechanical system according to claim 1, further comprising:
an interface board, disposed independently of the mainboard, wherein the interface board is electrically connected to the mainboard, and is configured to provide a power supply signal for at least one of the light emission assembly, the light receiving assembly, or the light scanning assembly.

10. The opto-mechanical system according to claim 9, further comprising:
a housing having a first accommodating cavity, wherein the light emission assembly, the light receiving assembly, the mainboard, the light scanning assembly, the electronic control board, and the interface board are located in the first accommodating cavity, wherein
a fourth heat conduction member is disposed between the mainboard and the housing; or a fifth heat conduction member is disposed between the electronic control board and the housing; or a sixth heat conduction member is disposed between the interface board and the housing.

11. The opto-mechanical system according to claim 1, further comprising:
a housing having a first accommodating cavity, wherein the light emission assembly, the light receiving assembly, the light scanning assembly, the mainboard, and the electronic control board are all located in the first accommodating cavity, and the housing comprises a first board; and
a separating member, located in the first accommodating cavity and spaced apart from the first board, wherein the mainboard is disposed between the first board and the separating member, and the first board and the separating member are both metal members.

12. An opto-mechanical system, comprising:
a light emission assembly;
a light receiving assembly;
a mainboard, wherein the mainboard is electrically connected to the light emission assembly and configured to control the light emission assembly to emit an emission light signal to an irradiated object, and is electrically connected to the light receiving assembly and configured to control the light receiving assembly to receive an echo light signal reflected by the irradiated object;
a housing having a first accommodating cavity, wherein the light emission assembly, the light receiving assembly, and the mainboard are all located in the first accommodating cavity, and the housing comprises a first board; and
a separating member, located in the first accommodating cavity and spaced apart from the first board, wherein the mainboard is disposed between the first board and the separating member, and the first board and the separating member are both metal members.

13. The opto-mechanical system according to claim 12, wherein the housing is a metal member.

14. The opto-mechanical system according to claim 12, wherein the light receiving assembly comprises a light receiver, a receiving board, and a receiving shielding cover, the light receiver is mounted on the receiving board and electrically connected to the receiving board, the receiving board is electrically connected to the mainboard, the receiving shielding cover covers the light receiver, and the receiving shielding cover is provided with a first through hole for the echo light signal to pass through to reach the light receiver; or
the light emission assembly comprises a light emitter, an emission board, and an emission shielding cover, the light emitter is mounted on the emission board and electrically connected to the emission board, the emission board is electrically connected to the mainboard, the emission shielding cover covers the light emitter, and the emission shielding cover is provided with a second through hole for an emission light signal emitted by the light emitter to pass through.

15. The opto-mechanical system according to claim 12, wherein the separating member forms an emission light channel, the emission light channel has a first light inlet and a first light outlet, and the light emission assembly is disposed to correspond to the first light inlet and connected to the separating member; or
the separating member forms an echo light channel, wherein the echo light channel has a second light inlet and a second light outlet, and the light receiving assembly is disposed to correspond to the second light outlet and connected to the separating member.

16. The opto-mechanical system according to claim 15, wherein the separating member comprises:
a surrounding plate, located in the first accommodating cavity and disposed on a side of the mainboard that is farther away from the first board, and the surrounding plate forms a second accommodating cavity and the first light inlet, wherein the second accommodating cavity communicates with the first light outlet, the second light inlet, and the second light outlet; and
a first cover plate, located between the surrounding plate and the mainboard and connected to the surrounding plate, wherein the first cover plate together with the surrounding plate forms the second accommodating cavity.

17. The opto-mechanical system according to claim 16, wherein the first cover plate is a metal member.

18. The opto-mechanical system according to claim 15, wherein the separating member forms the emission light channel and the echo light channel, and at least part of the emission light channel and at least part of the echo light channel are separated.

19. The opto-mechanical system according to claim 12, further comprising a light scanning assembly, wherein
the emission light signal is transmitted by the light scanning assembly to the irradiated object, and the echo light signal is transmitted by the light scanning assembly to the light receiving assembly; and
the mainboard is further electrically connected to the light scanning assembly and configured to control a movement of the light scanning assembly.

20. The opto-mechanical system according to claim 19, further comprising:
an electronic control board, disposed in the first accommodating cavity and disposed independently of the mainboard, wherein the electronic control board is electrically connected to the mainboard, and the electronic control board is electrically connected to the light scanning assembly to control a movement of the light scanning assembly.
